(19) United States
(12) Patent Application Publication
(10) Pub. No.: US 2026/0189143 A1
(43) Pub. Date: Jul. 2, 2026

(54) POWER CONVERTER AND CONTROL METHOD THEREOF

(71) Applicant: JND ELECTRONIC TECHNOLOGY (SHANGHAI) CO., LTD., Shanghai (CN)

(72) Inventors: Qiang LI, Shanghai (CN); Yu ZHANG, Shanghai (CN)

(73) Assignee: JND ELECTRONIC TECHNOLOGY (SHANGHAI) CO., LTD., Shanghai (CN)

(21) Appl. No.: 19/063,685

(22) Filed: Feb. 26, 2025

(30) Foreign Application Priority Data
Dec. 30, 2024 (CN) 2024119767589

(51) Int. Cl. H02M 3/158; H02M 3/07

(52) U.S. Cl. CPC H02M 3/158; H02M 3/07

(57) ABSTRACT

The present disclosure relates to the technical field of power electronics, and in particular to a power converter and a control method thereof. The power converter proposed in the present disclosure is suitable for outputting a stable voltage according to a wide range of input voltages, and controlling a conductive state of each switch in a specific time region according to a duty ratio of the power converter so as to avoid generation of a reverse current, and at the same time reducing generation of heat energy improving a stability of a circuit and a conversion efficiency of the power converter; secondly, a voltage value of the input voltage can be shared by setting a first capacitor Cb1 and a second capacitor Cb2, such that duty ratios of all the switches can be doubled, further reducing difficulty in setting voltage stresses of all the switches and their corresponding control signals.

### CROSS-REFERENCE TO RELATED APPLICATIONS

The application claims priority to Chinese patent application No. 202411976758.9, filed on Dec. 30, 2024, the entire contents of which are incorporated herein by reference.

### TECHNICAL FIELD

The present disclosure relates to the technical field of power electronics, particularly to a power converter and a control method thereof.

### BACKGROUND

Power converters are the core components in the development of social technology. At the technical level, the key requirement for power converters is to reduce losses to achieve high efficiency and high power density. Nowadays, in many application scenarios, it is often necessary to convert a voltage of 54 V to a voltage of 12 V, which is increasingly important. For example, in some industrial automation equipment, some modules of a communication base station, etc. the conversion efficiency and power density from 54 V to 12 V may directly affect the performance, stability and power consumption of the equipment.

For a wide range of input voltages, it is often difficult for prior art buck power converters to meet an output of a stable voltage value. For example, when the input voltage is active at 48 V-54 V, a stable output of 12 V can also be achieved by adjustment of a duty ratio of the buck power converter, but when the input voltage is active at 40 V-48 V, a conventional buck power converter cannot output a stable voltage of 12 V by adjustment of the duty ratio. In particular, when the input voltage is lower than 48 V, in order to maintain a stable output of 12V, the duty ratio of the buck power converter will exceed 50%. In this case, when the switch in the buck power converter is switched, the series voltage after the combination of energy storage capacitors used for storing and releasing energy in the circuit is not equal to a voltage across the input capacitor. If the series voltage after the combination of the energy storage capacitors is greater than the voltage across the input capacitor, this voltage mismatch will cause a reverse impact by the current. Since the input capacitor will try to maintain its charge when the voltage changes, as a result, a momentary large current is generated in the circuit, and such the reverse impact by the current will not only affect the stability of the circuit, but also lead to a reduction in the efficiency of the power conversion circuit and the generation of heat energy, thereby causing a safety hazard.

Given this, overcoming the shortcomings of the existing technology is an urgent problem that needs to be solved in this technical field.

### SUMMARY

The technical problem to be solved by the present disclosure is how to realize a power converter to output a stable voltage over a wide input voltage range and avoid generating a reverse current.

The present disclosure adopts the following technical solution:

In a first aspect, there is provided a power converter, including: a first bridge arm composed of a plurality of switches, a second bridge arm composed of a plurality of switches, a first capacitor Cb1, a second capacitor Cb2 and an inductance assembly, wherein one end of the first bridge arm is connected to a first input end Vin+ of the power converter, and the other end thereof is connected to a second input end Vin−; one end of the second bridge arm is connected to the first input end Vin+ of the power converter, and the other end thereof is connected to the second input end Vin−; and a input capacitor Cin is provided between the first input end Vin+ and the second input end Vin−;
a second node and a third node are provided on the first bridge arm, and a first node and a fourth node are provided on the second bridge arm; and the first node, the second node, the third node and the fourth node are respectively located on a connection line between two adjacent switches;
the first node is connected to one end of the first capacitor Cb1; the other end of the first capacitor Cb1 is connected to the second node; the third node is connected to one end of the second capacitor Cb2; the other end of the second capacitor Cb2 is connected to the fourth node; the second node and the fourth node are respectively connected to one end of the inductance assembly, and the other end of the inductance assembly is connected to a first output end Vout+ of the power converter, wherein a conductive state of each switch is respectively controlled in a specific time region according to a duty ratio of the power converter, such that the first capacitor Cb1 and the second capacitor Cb2 do not form a loop with the input capacitor Cin, or voltages across the first capacitor Cb1 and the second capacitor Cb2 are both lower than a voltage across the input capacitor Cin.

Preferably, it includes: a first switch Q1, a second switch Q2, a third switch Q3 and a fourth switch Q4 successively connected to constitute the first bridge arm, and a fifth switch Q5, a sixth switch Q6, a seventh switch Q7 and an eighth switch Q8 successively connected to constitute the second bridge arm, wherein one end of the first switch Q1 and one end of the fifth switch Q5 are respectively connected to the first input end Vin+; and one end of the fourth switch Q4 and one end of the eighth switch Q8 are respectively connected to the second input end Vin−;
the first node between the sixth switch Q6 and the seventh switch Q7 is connected to one end of the first capacitor Cb1; and the other end of the first capacitor Cb1 is connected to the second node between the third switch Q3 and the fourth switch Q4;
the third node between the second switch Q2 and the third switch Q3 is connected to one end of the second capacitor Cb2; and the other end of the second capacitor Cb2 is connected to the fourth node between the seventh switch Q7 and the eighth switch Q8; and the first switch Q1 and the fifth switch Q5 share a source electrode, the first switch Q1 and the second switch Q2 share a drain electrode, and the fifth switch Q5 and the sixth switch Q6 share a drain electrode.

Preferably, it includes: a second switch Q2, a first switch Q1, a third switch Q3 and a fourth switch Q4 successively connected to constitute the first bridge arm, and a sixth switch Q6, a fifth switch Q5, a seventh switch Q7 and an eighth switch Q8 successively connected to constitute the second bridge arm, wherein one end of the second switch Q2 and one end of the sixth switch Q6 are respectively connected to the first input end Vin+; and one end of the fourth switch Q4 and one end of the eighth switch Q8 are respectively connected to the second input end Vin−;
the first node between the fifth switch Q5 and the seventh switch Q7 is connected to one end of the first capacitor Cb1; and the other end of the first capacitor Cb1 is connected to the second node between the third switch Q3 and the fourth switch Q4;
the third node between the first switch Q1 and the third switch Q3 is connected to one end of the second capacitor Cb2; and the other end of the second capacitor Cb2 is connected to the fourth node between the seventh switch Q7 and the eighth switch Q8; and the first switch Q1 and the second switch Q2 share a source electrode, and the fifth switch Q5 and the sixth switch Q6 share a source electrode.

Preferably, the power converter further includes a PWM control module, wherein the PWM control module is respectively connected to control ends of the first switch Q1, the second switch Q2, the third switch Q3, the fourth switch Q4, the fifth switch Q5, the sixth switch Q6, the seventh switch Q7 and the eighth switch Q8; and the PWM control module is used for respectively issuing corresponding PWM control signals to the first switch Q1, the second switch Q2, the third switch Q3, the fourth switch Q4, the fifth switch Q5, the sixth switch Q6, the seventh switch Q7 and the eighth switch Q8 so as to control an on-off state of each switch at different moments.

Preferably, the first switch Q1, the second switch Q2, the third switch Q3, the fourth switch Q4, the fifth switch Q5, the sixth switch Q6, the seventh switch Q7 and the eighth switch Q8 have a same switching frequency.

Preferably, the power converter further includes an input inductor Lin, an output inductor Ls and an output capacitor Cout; one end of the input inductor Lin is connected to the first input end Vin+ of the power converter, and the other end of the input inductor Lin is respectively connected to one end of the input capacitor Cin, one end of the first switch Q1 and one end of the fifth switch Q5; and one end of the output inductor Ls is connected to the other end of the inductance assembly, and the other end of the output inductor Ls is connected to the first output end Vout+ of the power converter; and one end of the output capacitor Cout is connected to the first output end Vout+ of the power converter, and the other end of the output capacitor Cout is connected to the second output end Vout− of the power converter.

Preferably, the inductance assembly is a discrete inductor, and the inductance assembly includes a first inductor Lq1 and a second inductor Lq2, wherein one end of the first inductor Lq1 is connected to the second node, and the other end of the first inductor Lq1 is connected to the first output end Vout+ of the power converter; and one end of the second inductor Lq2 is connected to the fourth node, and the other end of the second inductor Lq2 is connected to the first output end Vout+ of the power converter.

Preferably, the inductance assembly is a coupled inductor, and the inductance assembly includes a third inductor Lq1′ and a fourth inductor Lq2′, wherein one end of the third inductor Lq1′ is connected to the second node, and the other end of the third inductor Lq1′ is connected to the first output end Vout+ of the power converter; one end of the fourth inductor Lq2′ is connected to the fourth node, and the other end of the fourth inductor Lq2′ is connected to the first output end Vout+ of the power converter; and the third inductor Lq1′ and the fourth inductor Lq2′ are wound around one same magnetic core assembly, polarities of the third inductor Lq1′ and the fourth inductor Lq2′ are opposite, and an absolute value of a coupling coefficient of the third inductor Lq1′ and the fourth inductor Lq2′ ranges from 0 to 1.

In a second aspect, there is provided a control method of a power converter implemented in the power converter according to the first aspect, including:
when the duty ratio of the power converter is less than or equal to a pre-set threshold value, constructing a first timing sequence control diagram corresponding to each switch, and generating a corresponding PWM control signal according to the first timing sequence control diagram so as to control turn-off or conduction of each switch, wherein a first switch Q1 and a fifth switch Q5 are kept in a conductive state; and when the duty ratio of the power converter is greater than the pre-set threshold value, constructing a second timing sequence control diagram corresponding to each switch, and generating the corresponding PWM control signal according to the second timing sequence control diagram so as to control the turn-off or conduction of each switch, wherein the first switch Q1 is controlled to be conductive or the fifth switch Q5 is controlled to be conductive during a time period when a reverse current surge occurs, so as to avoid generation of a reverse current.

Preferably, the first bridge arm includes a first switch Q1, a second switch Q2, a third switch Q3 and a fourth switch Q4, and the second bridge arm includes a fifth switch Q5, a sixth switch Q6, a seventh switch Q7 and an eighth switch Q8, and in the first timing sequence control diagram:
a sixth control signal on the sixth switch Q6 has a same phase as a third control signal on the third switch Q3; a second control signal on the second switch Q2 has a same phase as a seventh control signal on the seventh switch Q7; the sixth control signal on the sixth switch Q6 is 180 degrees phase shifted from a fourth control signal on the fourth switch Q4; the second control signal on the second switch Q2 is 180 degrees phase shifted from an eighth control signal on the eighth switch Q8; the sixth control signal on the sixth switch Q6 is 180 degrees phase shifted from the second control signal on the second switch Q2; the fourth control signal on the fourth switch Q4 is 180 degrees phase shifted from the eighth control signal on the eighth switch Q8; and the first switch Q1 and the fifth switch Q5 maintain the conductive state.

Preferably, the first bridge arm includes a first switch Q1, a second switch Q2, a third switch Q3 and a fourth switch Q4, and the second bridge arm includes a fifth switch Q5, a sixth switch Q6, a seventh switch Q7 and an eighth switch Q8, and in the second timing sequence control diagram:
a seventh control signal on the seventh switch Q7 has a same phase as a fourth control signal on the fourth switch Q4; a third control signal on the third switch Q3 has a same phase as an eighth control signal on the eighth switch Q8; a sixth control signal on the sixth switch Q6 is 180 degrees phase shifted from the seventh control signal on the seventh switch Q7; the seventh control signal on the seventh switch Q7 is also 180 degrees phase shifted from the third control signal on the third switch Q3; and the third control signal on the third switch Q3 is 180 degrees phase shifted from a second control signal on the second switch Q2.

Advantageous effects of the present disclosure compared with prior art are provided as follows.

The power converter proposed in the present disclosure can output a stable voltage according to a wide range of input voltages and is suitable for outputting a stable voltage according to a wide range of input voltages, and controlling a conductive state of each switch in a specific time region according to a duty ratio of the power converter so as to avoid generation of a reverse current, and at the same time reducing generation of heat energy improving a stability of a circuit and a conversion efficiency of the power converter; secondly, a voltage value of the input voltage can be shared by setting a first capacitor Cb1 and a second capacitor Cb2, such that duty ratios of all the switches can be doubled, further reducing difficulty in setting voltage stresses of all the switches and their corresponding control signals.

### BRIEF DESCRIPTION OF DRAWINGS

In order to explain the technical solutions in the embodiments of the present disclosure or in prior art more clearly, the following contents will briefly introduce the drawing which needs to be used in the embodiments or in prior art. It would be obvious that the drawing in the following description is only an embodiment of the present disclosure, and it is possible for a person skilled in the art to obtain other drawings according to this drawing provided without involving any inventive effort.

FIG. 1 is a schematic structural diagram of a power converter in which a recoil current exists according to an embodiment of the present disclosure;

FIG. 1a is a schematic diagram of a waveform of a recoil current according to an embodiment of the present disclosure;

FIG. 2 is a specific schematic structural diagram of a power converter according to an embodiment of the present disclosure;

FIG. 2a is a specific schematic structural diagram of another power converter according to an embodiment of the present disclosure;

FIG. 2b is a schematic structural diagram of a driving power source and a driving circuit of a power converter according to an embodiment of the present disclosure;

FIG. 2c is a schematic structural diagram of a driving power source and a driving circuit of another power converter according to an embodiment of the present disclosure;

FIG. 2d is a schematic diagram of a waveform without generation of a recoil current according to an embodiment of the present disclosure;

FIG. 3 is another specific schematic structural diagram of a power converter according to an embodiment of the present disclosure;

FIG. 4 is a schematic flow diagram of a control method of a power converter according to an embodiment of the present disclosure;

FIG. 5 is a timing sequence diagram for switch control of a power converter with a duty ratio less than or equal to 50% according to an embodiment of the present disclosure;

FIG. 6 is a timing sequence diagram for switch control of a power converter with a duty ratio greater than 50% according to an embodiment of the present disclosure;

FIG. 7 is a schematic diagram of a modal circuit of the timing sequence diagram for switch control within t0-t1 of FIG. 5 according to an embodiment of the present disclosure;

FIG. 8 is a schematic diagram of a modal circuit of the timing sequence diagram for switch control within t1-t2 of FIG. 5 according to an embodiment of the present disclosure;

FIG. 9 is a schematic diagram of a modal circuit of the timing sequence diagram for switch control within t2-t3 of FIG. 5 according to an embodiment of the present disclosure;

FIG. 10 is a schematic diagram of a modal circuit of the timing sequence diagram for switch control within t3-t4 of FIG. 5 according to an embodiment of the present disclosure;

FIG. 11 is a schematic diagram of a modal circuit of the timing sequence diagram for switch control within t4-t5 of FIG. 5 according to an embodiment of the present disclosure;

FIG. 12 is a schematic diagram of a modal circuit of the timing sequence diagram for switch control within t5-t6 of FIG. 5 according to an embodiment of the present disclosure;

FIG. 13 is a schematic diagram of a modal circuit of the timing sequence diagram for switch control within t6-t7 of FIG. 5 according to an embodiment of the present disclosure;

FIG. 14 is a schematic diagram of a modal circuit of the timing sequence diagram for switch control within t7-t8 of FIG. 5 according to an embodiment of the present disclosure;

FIG. 15 is a schematic diagram of a modal circuit of the timing sequence diagram for switch control within t0-t1 of FIG. 6 according to an embodiment of the present disclosure;

FIG. 16 is a schematic diagram of a modal circuit of the timing sequence diagram for switch control within t1-t2 of FIG. 6 according to an embodiment of the present disclosure;

FIG. 17 is a schematic diagram of a modal circuit of the timing sequence diagram for switch control within t2-t3 of FIG. 6 according to an embodiment of the present disclosure;

FIG. 18 is a schematic diagram of a modal circuit of the timing sequence diagram for switch control within t3-t4 of FIG. 6 according to an embodiment of the present disclosure;

FIG. 19 is a schematic diagram of a modal circuit of the timing sequence diagram for switch control within t4-t5 of FIG. 6 according to an embodiment of the present disclosure;

FIG. 20 is a schematic diagram of a modal circuit of the timing sequence diagram for switch control within t5-t6 of FIG. 6 according to an embodiment of the present disclosure;

FIG. 21 is a schematic diagram of a modal circuit of the timing sequence diagram for switch control within t6-t7 of FIG. 6 according to an embodiment of the present disclosure;

FIG. 22 is a schematic diagram of a modal circuit of the timing sequence diagram for switch control within t7-t8 of FIG. 6 according to an embodiment of the present disclosure;

FIG. 23 is a schematic diagram of a modal circuit of the timing sequence diagram for switch control within t8-t9 of FIG. 6 according to an embodiment of the present disclosure;

FIG. 24 is a schematic diagram of a modal circuit of the timing sequence diagram for switch control within t9-t10 of FIG. 6 according to an embodiment of the present disclosure.

### DETAILED DESCRIPTION OF THE EMBODIMENTS

In order that the objects, technical solutions and advantages of the present disclosure may be more clearly understood, the present disclosure will be described in further detail below in combination with the accompanying drawings and the embodiments. It should be understood that the particular embodiments described herein are illustrative only and are not restrictive.

Unless the context requires otherwise, throughout the description and the claims, the term “comprise” is to be construed in an open, inclusive sense, that is as “including, but not limited to”. In the description, the terms “an embodiment”, “some embodiments”, “exemplary embodiment”, “example”, “specific example” or “some examples” are intended to indicate that specific features, structures, materials or characteristics related to the embodiment or example are included in at least one embodiment or example disclosed herein. The schematic representation of the foregoing terms does not necessarily refer to one same embodiment or example. Furthermore, the particular features, structures, materials, or characteristics described may be included in any suitable manner in any one or more of the embodiments or examples, namely, although they may be carried in the embodiments or examples of the foregoing terms due to their appearance order and position, it is not limited and they can be carried in combination by one embodiment or example.

In the description the present disclosure, the terms “first”, “second” and the like are only used for descriptive purposes, and are not to be construed as indicating or implying relative importance or implicitly indicating the quantity of technical features indicated. Thus, features defined with “first” or “second” may explicitly or implicitly include one or more of the feature. In the embodiments of the present disclosure, the meaning of “plurality” is two or more, unless indicated otherwise. In addition, for example, in description, the same type of nouns may also be described as two independent individuals by adding “A” and “B” at the end. In this case, the corresponding features with limitations of “A” and “B” are only used for description purpose to distinguish similar individuals, and cannot be understood as indicating or implying relative importance or implying the quantity of technical features indicated.

In describing some embodiments, the terms “coupled”, “coupled to”, and “connected”, along with their derivatives, may be used. For example, the term “connected” may be used when describing some embodiments to indicate that two or more component are in direct physical or electrical contact with each other. As another example, the term “coupled” may be used when describing some embodiments to indicate that two or more components are in direct physical or electrical contact. However, the terms “connected” or “coupled” may also mean that two or more components are not in direct contact with each other, but yet still co-operate or interact with each other, e.g. “optically coupled”, “wirelessly connected”, etc. The embodiments disclosed herein are not necessarily limited by the present disclosure.

Furthermore, the technical features involved in the various embodiments of the present disclosure described below can be combined with each other as long as they do not conflict with each other.

### Embodiment 1

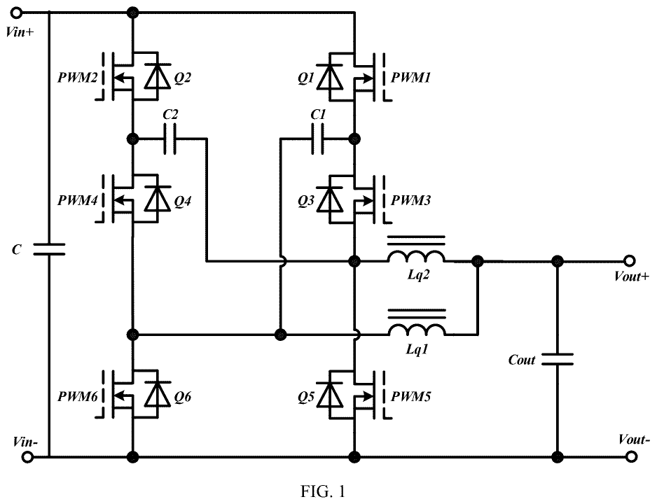

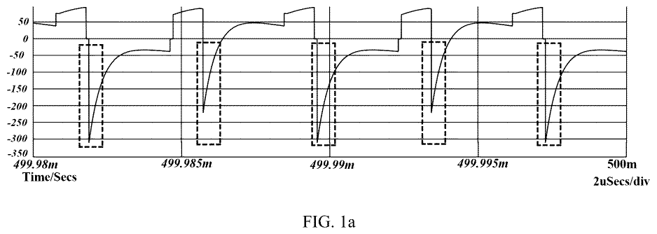

Before describing the power converter according to the present disclosure in detail, a buck power converter is proposed in the present embodiment. As shown in FIG. 1, the buck power converter can convert an input voltage of 54 V into a stable output voltage of 12 V. Compared with the traditional BUCK step-down circuit, its duty ratio can be doubled and the voltage can be converted more efficiently in the same time. Secondly, the buck power converter can greatly reduce an effective value of the current, thereby reducing the energy loss in the circuit; at the same time, the stress of the power switch in the circuit will be greatly reduced, which can extend the service life of the power switch elements and improve the reliability of the whole circuit. It should be noted that the reference numerals in FIG. 1 are used by way of example only and do not conflict with the reference numerals of the drawings in the embodiments described below.

The applicant has found through research that for a wide range of input voltages, it is often difficult for the buck power converters to meet an output of a stable voltage value. For example, when the input voltage is active at 48 V-54 V, a stable output of 12 V can also be achieved by adjustment of a duty ratio of the buck power converter, but when the input voltage is active at 40 V-48 V, a conventional buck power converter cannot output a stable voltage of 12 V by adjustment of the duty ratio. In particular, when the input voltage is lower than 48 V, in order to maintain a stable output of 12 V, the duty ratio of the buck power converter will exceed 50%. In this case, when the switch in the buck power converter is switched, the series voltage after the combination of energy storage capacitors used for storing and releasing energy in the circuit is not equal to A voltage across the input capacitor. If the series voltage after the combination of the energy storage capacitors is greater than the voltage across the input capacitor, this voltage mismatch will cause a reverse impact by the current. Since the input capacitor will try to maintain its charge when the voltage changes, as a result, a momentary large current is generated in the circuit. In one embodiment, as shown in FIG. 1a, wherein an abscissa is time, an ordinate collects a current value of a capacitor cb1 or a capacitor cb2, and a dotted box shows a waveform variation of a recoil current therein. This reverse impact by the current not only affects the stability of the circuit, but also results in reduced efficiency of the power conversion circuit and the generation of thermal energy, which causes the safety hazard.

In order to solve the above-mentioned problem that the buck power converter generates a recoil current in performing a process of outputting a stable voltage according to a wide range of voltage inputs, thereby affecting circuit stability, the present embodiment proposes another power converter.

In one embodiment, it includes: a first bridge arm composed of a plurality of switches, a second bridge arm composed of a plurality of switches, a first capacitor Cb1, a second capacitor Cb2 and an inductance assembly, wherein one end of the first bridge arm is connected to a first input end Vin+ of the power converter, and the other end thereof is connected to a second input end Vin−; one end of the second bridge arm is connected to the first input end Vin+ of the power converter, and the other end thereof is connected to the second input end Vin−; an input capacitor Cin is provided between the first input end Vin+ and the second input end Vin−; a second node (denoted by B) and a third node (denoted by C) are provided on the first bridge arm, and a first node (denoted by A) and a fourth node (denoted by D) are provided on the second bridge arm; the first node, the second node, the third node and the fourth node are respectively located on a connection line between two adjacent switches; the first node is connected to one end of the first capacitor Cbl; the other end of the first capacitor Cb1 is connected to the second node; the third node is connected to one end of the second capacitor Cb2; the other end of the second capacitor Cb2 is connected to the fourth node; the second node and the fourth node are respectively connected to one end of the inductance assembly, and the other end of the inductance assembly is connected to a first output end Vout+ of the power converter, wherein a conductive state of each switch is respectively controlled in a specific time region according to a duty ratio of the power converter, such that the first capacitor Cb1 and the second capacitor Cb2 do not form a loop with the input capacitor Cin, or voltages across the first capacitor Cb1 and the second capacitor Cb2 are both lower than a voltage across the input capacitor Cin.

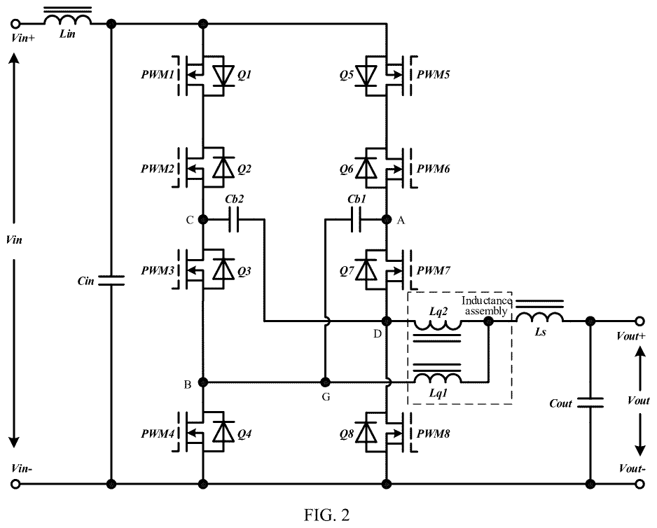

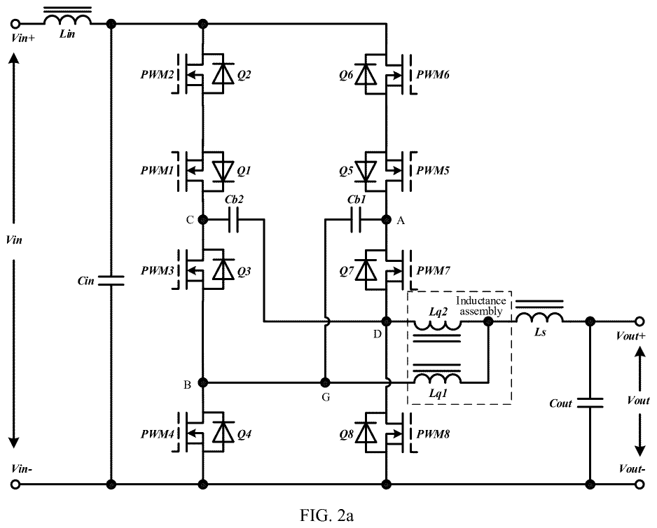

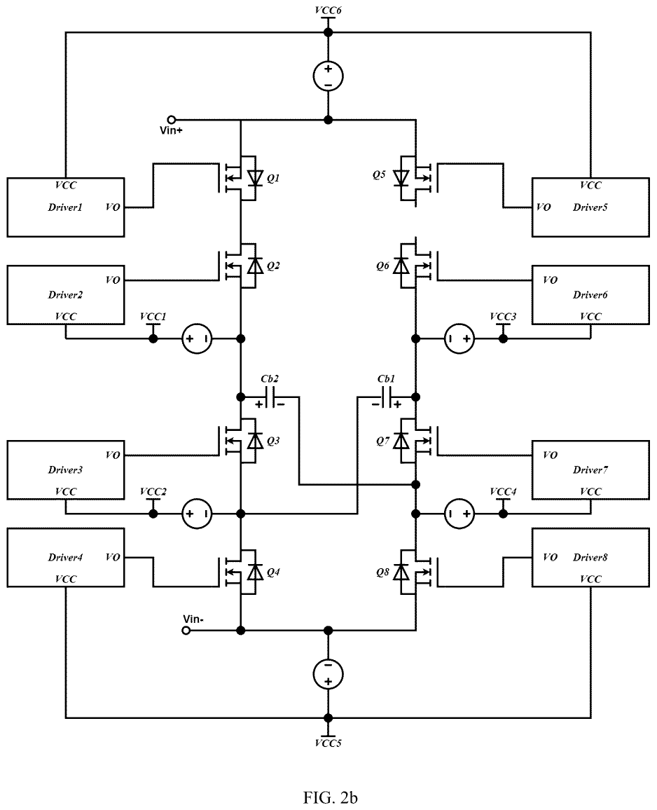

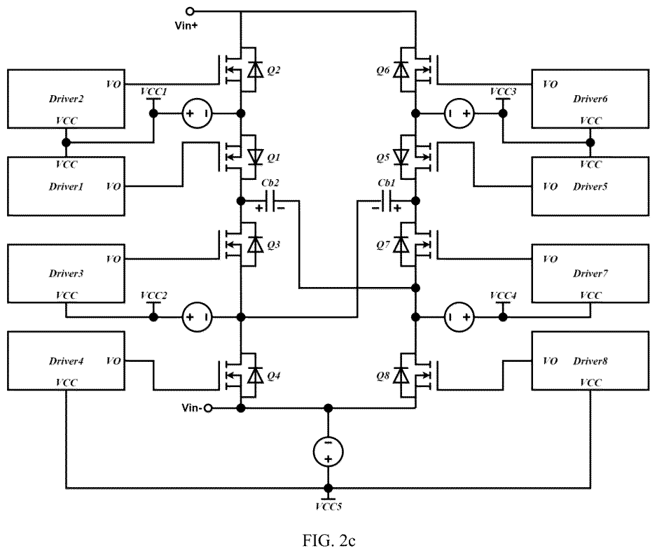

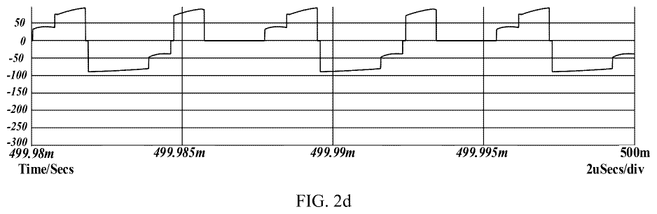

According to the connection relationship between the switches, this embodiment proposes circuit structures of at least two types of power converters. In one embodiment, the circuit structure of the first power converter is as shown in FIG. 2, including: a first switch Q1, a second switch Q2, a third switch Q3 and a fourth switch Q4 successively connected to constitute the first bridge arm, and a fifth switch Q5, a sixth switch Q6, a seventh switch Q7 and an eighth switch Q8 successively connected to constitute the second bridge arm, wherein one end of the first switch Q1 and one end of the fifth switch Q5 are respectively connected to the first input end Vin+; one end of the fourth switch Q4 and one end of the eighth switch Q8 are respectively connected to the second input end Vin−; the first node between the sixth switch Q6 and the seventh switch Q7 is connected to one end of the first capacitor Cb1; the other end of the first capacitor Cb1 is connected to the second node between the third switch Q3 and the fourth switch Q4; the third node between the second switch Q2 and the third switch Q3 is connected to one end of the second capacitor Cb2; the other end of the second capacitor Cb2 is connected to the fourth node between the seventh switch Q7 and the eighth switch Q8; the first switch Q1 and the fifth switch Q5 share a source electrode, the first switch Q1 and the second switch Q2 share a drain electrode, and the fifth switch Q5 and the sixth switch Q6 share the drain electrode.

In one embodiment, the circuit structure of the second power converter is as shown in FIG. 2a, including: a second switch Q2, a first switch Q1, a third switch Q3 and a fourth switch Q4 successively connected to constitute the first bridge arm, and a sixth switch Q6, a fifth switch Q5, a seventh switch Q7 and an eighth switch Q8 successively connected to constitute the second bridge arm; one end of the second switch Q2 and one end of the sixth switch Q6 are respectively connected to the first input end Vin+; one end of the fourth switch Q4 and one end of the eighth switch Q8 are respectively connected to the second input end Vin−; the first node between the fifth switch Q5 and the seventh switch Q7 is connected to one end of the first capacitor Cb1; the other end of the first capacitor Cb1 is connected to the second node between the third switch Q3 and the fourth switch Q4; the third node between the first switch Q1 and the third switch Q3 is connected to one end of the second capacitor Cb2; the other end of the second capacitor Cb2 is connected to the fourth node between the seventh switch Q7 and the eighth switch Q8; and the first switch Q1 and the second switch Q2 share a source electrode, and the fifth switch Q5 and the sixth switch Q6 share the source electrode.

When the first switch Q1, the second switch Q2, the third switch Q3, the fourth switch Q4, the fifth switch Q5, the sixth switch Q6, the seventh switch Q7 and the eighth switch Q8 are all MOS switch tubes, and all the MOS switch tubes are N-type MOS switch tubes (P-type MOS switch tubes are of the same principle, about which this embodiment will not describe too much), each switch has a PWM control module corresponding thereto, and the PWM control module is connected to a gate electrode and a source electrode of the MOS switch tube; the PWM control module includes a driving circuit (represented by Driver) and a driving power source (represented by VCC), wherein the driving power source is used for providing energy for the driving circuit, and the driving circuit is used for providing a driving signal for the MOS switch tubes (the first switch Q1-the eighth switch Q8), wherein, when a plurality of MOS switch tubes are connected in a common source electrode, a plurality of driving circuits can share the same driving power source to provide driving signals for the plurality of MOS switch tubes.

In one embodiment, referring to FIGS. 2 and 2b, it can be seen that the first switch Q1 and the fifth switch Q5 share a source electrode, the first switch Q1 and the second switch Q2 share a drain electrode, and the fifth switch Q5 and the sixth switch Q6 share a drain electrode. At this time, the second switch Q2 uses a driving power source VCC1 alone, the third switch Q3 uses the driving power source VCC2 alone, the sixth switch Q6 uses the driving power source VCC3 alone, the seventh switch Q7 uses the driving power source VCC4 alone, the fourth switch Q4 and the eighth switch Q8 share the same driving power source VCC5, and the first switch Q1 and the fifth switch Q5 share the same driving power source VCC6. It can be seen from FIG. 2b that a total of six driving power sources are used for the circuit structure of the first power converter.

In one embodiment, as shown in FIGS. 2a and 2c, it can be seen that the first switch Q1 and the second switch Q2 share the same source electrode, the fifth switch Q5 and the sixth switch Q6 share the same source electrode, and at this time, the first switch Q1 and the second switch Q2 share the same driving power source VCC1, the third switch Q3 uses the driving power source VCC2 alone, the fifth switch Q5 and the sixth switch Q6 share the same driving power source VCC3, the seventh switch Q7 uses the driving power source VCC4 alone, and the fourth switch Q4 and the eighth switch Q8 share the same driving power source VCC5. It can be seen from FIG. 2c that a total of five driving power sources are used.

In view of the above-mentioned contents, the circuit structure of the second power converter shown in FIG. 2a uses one less driving power source than the circuit structure of the first power converter shown in FIG. 2, and saving the quantity of driving power sources can simplify the circuit design, save the product cost, and increase the power density of the power source.

The following embodiments will further illustrate the power converter in a circuit structure of the first power converter. In one embodiment, as shown in FIG. 2, it includes: a first bridge arm composed of a first switch Q1, a second switch Q2, a third switch Q3 and a fourth switch Q4 which are connected sequentially, a second bridge arm composed of a fifth switch Q5, a sixth switch Q6, a seventh switch Q7 and an eighth switch Q8 connected sequentially, a first capacitor Cb1, a second capacitor Cb2 and an inductance assembly.

One end of the first switch Q1 and one end of the fifth switch Q5 are respectively connected to a first input end Vin+ of the power converter; one end of the fourth switch Q4 and one end of the eighth switch Q8 are respectively connected to a second input end Vin− of the power converter; and an input capacitor Cin is provided between the first input end Vin+ and the second input end Vin−.

A first node (indicated by A in the drawing) between the sixth switch Q6 and the seventh switch Q7 is connected to one end of the first capacitor Cb1; the other end of the first capacitor Cb1 is connected to a second node (indicated by B in the drawing) between the third switch Q3 and the fourth switch Q4; the third node (indicated by C in the drawing) between the second switch Q2 and the third switch Q3 is connected to one end of the second capacitor Cb2; the other end of the second capacitor Cb2 is connected to a fourth node (indicated by D in the drawing) between the seventh switch Q7 and the eighth switch Q8; the second node and the fourth node are respectively connected to one end of the inductance assembly, and the other end of the inductance assembly is connected to a first output end Vout+ of the power converter.

In practical use, a conductive state of each switch is respectively controlled in a specific time region according to a duty ratio of the power converter, such that the first capacitor Cb1 and the second capacitor Cb2 do not form a loop with the input capacitor Cin, or voltages across the first capacitor Cb1 and the second capacitor Cb2 are both lower than a voltage across the input capacitor Cin so as to avoid generating a recoil current. In one embodiment, as shown in FIG. 2d, an abscissa is time, an ordinate is a current value of the first capacitor Cb1 or the second capacitor Cb2 in the circuit structure of the power converter shown in FIG. 2 or FIG. 2a, and when the recoil current disappears compared to FIG. 1a, it is proved that this embodiment can effectively eliminate the kickback voltage and maintain the stability of the power converter, and for a more specific implementation process, reference is made to the following embodiments.

In one embodiment, when the duty ratio of the power converter is less than or equal to a pre-set threshold value, a first timing sequence control diagram corresponding to each switch is constructed, and a corresponding PWM control signal is generated according to the first timing sequence control diagram so as to control turn-off or conduction of each switch, wherein a first switch Q1 and a fifth switch Q5 are kept in a conductive state; and when the duty ratio of the power converter is greater than the pre-set threshold value, a second timing sequence control diagram corresponding to each switch is constructed, and the corresponding PWM control signal is generated according to the second timing sequence control diagram so as to control the turn-off or conduction of each switch, wherein the first switch Q1 is controlled to be conductive or the fifth switch Q5 is controlled to be conductive during a time period when a reverse current surge occurs, so as to avoid generation of a reverse current. A more specific control method is described in Embodiment 2.

The second input end Vin− of the power converter and the second output end Vout− of the power converter are ground ends.

In one embodiment, with reference to FIG. 2, the input voltage Vin is a wide range of input voltage Vin provided by a back-end circuit, and a range value of the input voltage Vin may be 40 V60 V (namely, may be 40 V, may be 60 V, or may be any voltage value between 40 V-60 V); the output voltage Vout is used to provide a voltage for an electrical load as a stable value of voltage, and the value of the output voltage Vout ranges within 10 V-15 V (namely, may be 10 V, may be 15 V, or may be any voltage value between 10 V-15 V). The first capacitor Cb1 and the second capacitor Cb2 are used for sharing a voltage value of the input voltage Vin, such that duty ratios of all the switching power elements in the power converter can be set in a double manner, further reducing the difficulty in setting voltage stresses of all the switching power elements and the corresponding control signals.

In one embodiment, the first switch Q1, the second switch Q2, the third switch Q3, the fourth switch Q4, the fifth switch Q5, the sixth switch Q6, the seventh switch Q7, and the eighth switch Q8 are all MOS tubes or triodes.

With reference to FIG. 2, when the first switch Q1, the second switch Q2, the third switch Q3, the fourth switch Q4, the fifth switch Q5, the sixth switch Q6, the seventh switch Q7 and the eighth switch Q8 are all MOS tubes, a source electrode of the first switch Q1 is connected to the first input end Vin+ of the power converter, a drain electrode of the first switch Q1 is connected to a drain electrode of the second switch Q2, a source electrode of the second switch Q2 is connected to a drain electrode of the third switch Q3, a source electrode of the third switch Q3 is connected to a drain electrode of the fourth switch Q4, and a source electrode of the fourth switch Q4 is respectively connected to the second input end Vin− of the power converter and a second output end of the power converter; a source electrode of the fifth switch Q5 is connected to the first input end Vin+ of the power converter, a drain electrode of the fifth switch Q5 is connected to a drain electrode of the sixth switch Q6, a source electrode of the sixth switch Q6 is connected to a drain electrode of the seventh switch Q7, a source electrode of the seventh switch Q7 is connected to a drain electrode of the eighth switch Q8, and a source electrode of the eighth switch Q8 is respectively connected to the second input end Vin− of the power converter and the second output end of the power converter.

In one embodiment, the power converter further includes a PWM control module (not shown in the drawing), wherein the PWM control module is respectively connected to control ends (gate electrode corresponding to each switch)of the first switch Q1, the second switch Q2, the third switch Q3, the fourth switch Q4, the fifth switch Q5, the sixth switch Q6, the seventh switch Q7 and the eighth switch Q8; and the PWM control module is used for respectively issuing corresponding PWM control signals to the first switch Q1, the second switch Q2, the third switch Q3, the fourth switch Q4, the fifth switch Q5, the sixth switch Q6, the seventh switch Q7 and the eighth switch Q8 so as to control an on-off state of each switch at different moments.

In one embodiment, as shown in FIG. 2, the power converter further includes an input inductor Lin, an output inductor Ls and an output capacitor Cout; one end of the input inductor Lin is connected to the first input end Vin+ of the power converter, and the other end of the input inductor Lin is respectively connected to one end of the input capacitor Cin, one end of the first switch Q1 and one end of the fifth switch Q5; and one end of the output inductor Ls is connected to the other end of the inductance assembly, and the other end of the output inductor Ls is connected to the first output end Vout+ of the power converter; and one end of the output capacitor Cout is connected to the first output end Vout+ of the power converter, and the other end of the output capacitor Cout is connected to the second output end Vout− of the power converter.

The input inductor Lin, the input capacitor Cin, the output inductor Ls and the output capacitor Cout are respectively used for smoothing an input voltage or current, an output voltage or current and energy storage and filtering. Specific implementation principles are not described too much in this embodiment.

In one embodiment, the inductance assembly is a discrete inductor or a coupled inductor; as shown in FIG. 2, the inductance assembly is a discrete inductor, and the inductance assembly includes a first inductor Lq1 and a second inductor Lq2, wherein one end of the first inductor Lq1 is connected to the second node, and the other end of the first inductor Lq1 is connected to the first output end Vout+ of the power converter; and one end of the second inductor Lq2 is connected to the fourth node, and the other end of the second inductor Lq2 is connected to the first output end Vout+ of the power converter;

As a discrete inductor, the first inductor Lq1 and the second inductor Lq2 each operate independently and are mainly responsible for energy storage and filtering, and provide a continuous path of a current when a switch is switched, so as to reduce abrupt changes of the current, thereby reducing electromagnetic interference. The discrete inductor may provide greater flexibility and design freedom, allowing optimization for different application requirements. They can be independently selected to meet specific current and voltage requirements, and are easy to dissipate and integrate.

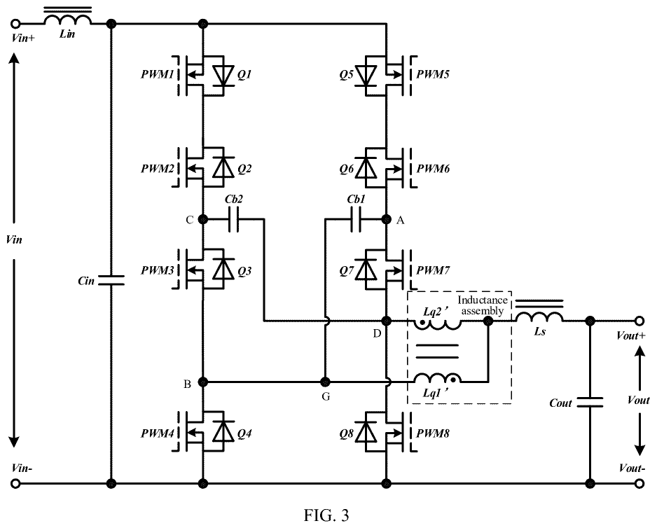

In one embodiment, as shown in FIG. 3, the inductance assembly is a coupled inductor, and the inductance assembly includes a third inductor Lq1′ and a fourth inductor Lq2′, wherein one end of the third inductor Lq1′ is connected to the second node, and the other end of the third inductor Lq1′ is connected to the first output end Vout+ of the power converter; one end of the fourth inductor Lq2′ is connected to the fourth node, and the other end of the fourth inductor Lq2′ is connected to the first output end Vout+ of the power converter; and the third inductor Lq1′ and the fourth inductor Lq2′ are wound around one same magnetic core assembly, polarities of the third inductor Lq1′ and the fourth inductor Lq2′ are opposite, and an absolute value of a coupling coefficient of the third inductor Lq1′ and the fourth inductor Lq2′ ranges from 0 to 1.

The conduction and turn-off of the switch causes the inductance assembly to be in a charged state or discharged state, thereby achieving a step down function. Specific implementation principles are not described too much in this embodiment.

Referring to FIG. 3, polarities of the first end of the third inductor Lq1′ and the first end of the fourth inductor Lq2′ are opposite, namely, polarities of the first end of the third inductor Lq1′ and the second end of the fourth inductor Lq2′ are the same (both are marked with a black dot). In one embodiment, the third inductor Lq1′ and the fourth inductor Lq2′ may be wound around the same magnetic core assembly to form a coupled inductor. The higher the absolute value of the coupling coefficient, the tighter the magnetic coupling between the two inductors, the less the magnetic flux, and the higher the energy transfer efficiency. For the coupled inductor, the absolute value of the coupling coefficient needs to satisfy the following relationship: when the coupling coefficient is close to 1, the magnetic coupling between the two inductors is strongest, meaning that the magnetic flux between the third inductor Lq1′ and the fourth inductor Lq2′ almost completely passes through the magnetic core of the other inductor, thereby achieving efficient magnetic energy conversion. Coupled inductors achieve mutual coupling of magnetic flux by sharing a magnetic core, which can make more efficient use of magnetic core materials and improve energy conversion efficiency. The coupled inductor can reduce the core material required, thereby reducing volume and weight, while improving the efficiency of magnetic energy utilization.

In one embodiment, the first switch Q1, the second switch Q2, the third switch Q3, the fourth switch Q4, the fifth switch Q5, the sixth switch Q6, the seventh switch Q7 and the eighth switch Q8 have a same switching frequency.

When the duty ratio of the power converter is less than or equal to 50%, no reverse current surge will occur, and therefore the first switch Q1 and the fifth switch Q5 will always remain in the conductive state. When the duty ratio of the power converter is more than 50%, with respect to the power converter shown in FIG. 1, by increasing the switching control of the first switch Q1 and the fifth switch Q5, only one branch (the first bridge arm or the second bridge arm) of the control switch is kept in the conductive state for a time period in which a current surge may occur, such that no reverse current surge occurs. Specific implementation principles will be described in detail in the following embodiments.

In one embodiment, the first switch Q1 and the fifth switch Q5 can be used as a current control switch, and a current control switch is respectively provided on the first bridge arm and the second bridge arm, and this method has the following advantages over providing a flow control switch on a main path:

(1) Switching frequency: when the current control switch is placed on the main path, its switching frequency will be twice that of the current control switches placed on the two bridge arms. A higher switching frequency results in more switching losses and higher requirements for the switching elements, which reduces the lifetime of the elements. By arranging the current control switches on the first bridge arm and the second bridge arm, excessive switching frequency is avoided, and switching losses and stress on elements are reduced.

(2) Circuit stability: in power converters, stability is a very important indicator. The current control switch provided on the bridge arm can ensure that no reverse current surge occurs at different duty ratios by controlling the conductive state in a specific time region, thereby improving the stability of the circuit. For example, when the duty ratio D is less than or equal to 50%, the first switch Q1 and the fifth switch Q5 will always remain in the conductive state, and no reverse current surge occurs in each time period; when the duty ratio D is greater than 50%, by increasing the switching control of the first switch Q1 and the fifth switch Q5, only one branch (the first bridge arm or the second bridge arm) of the control switch is kept in the conductive state during the period in which the current surge occurs, and the reverse current surge is effectively avoided.

(3) Reduced heat generation: the aspect of reducing thermal energy can be divided into two aspects: in a first aspect, the on-off losses of the switches are reduced due to the reduction of the switching frequency, thereby reducing the thermal energy on a single switch. In a second aspect, the switches on the main path are split into branches, and the driving losses of the original switches are split over two drivers on the two branches. The thermal energy of the switch driver is significantly reduced. A higher switching frequency results in more heat generation, which not only reduces the conversion efficiency of the power converter, but also affects the safety and reliability of the circuit. Providing the current control switches on the first bridge arm and the second bridge arm can reduce the thermal energy generated by the power converter and improve the operating safety of the power converter due to the lower switching frequency.

In summary, providing the current control switch on the first bridge arm and the second bridge arm has advantages of lower switching frequency, simple control, high circuit stability and less heat generation than providing the current control switch on the main path.

The power converter proposed in the present embodiment can output a stable voltage according to a wide range of input voltages and is suitable for outputting a stable voltage according to a wide range of input voltages, and controlling a conductive state of each switch in a specific time region according to a duty ratio of the power converter so as to avoid generation of a reverse current, and at the same time reducing generation of heat energy improving a stability of a circuit and a conversion efficiency of the power converter; secondly, a voltage value of the input voltage can be shared by setting a first capacitor Cb1 and a second capacitor Cb2, such that duty ratios of all the switches can be doubled, further reducing difficulty in setting voltage stresses of all the switches and their corresponding control signals.

### Embodiment 2

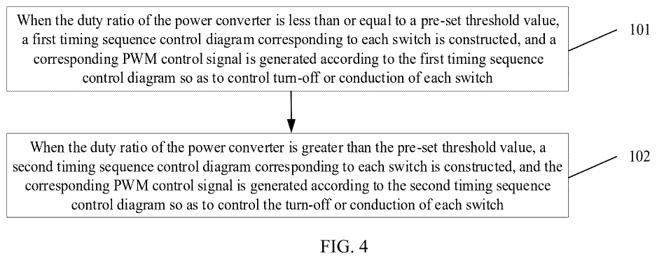

A power converter is proposed in Embodiment 1, and a control method of a power converter is proposed in this embodiment, as shown in FIG. 4, including:

Step 101: when the duty ratio of the power converter is less than or equal to a pre-set threshold value, a first timing sequence control diagram corresponding to each switch is constructed, and a corresponding PWM control signal is generated according to the first timing sequence control diagram so as to control turn-off or conduction of each switch, wherein a first switch Q1 and a fifth switch Q5 are kept in a conductive state.

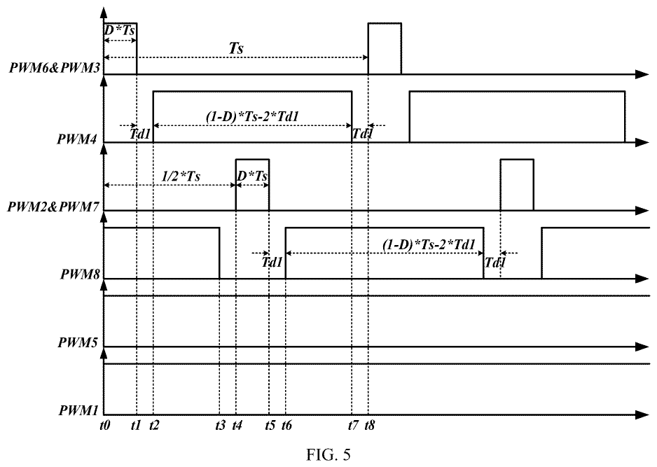

In one embodiment, as shown in FIG. 5, in the first timing sequence control diagram: a sixth control signal on the sixth switch Q6 has a same phase as a third control signal on the third switch Q3; a second control signal on the second switch Q2 has a same phase as a seventh control signal on the seventh switch Q7; the sixth control signal on the sixth switch Q6 is 180 degrees phase shifted from a fourth control signal on the fourth switch Q4; the second control signal on the second switch Q2 is 180 degrees phase shifted from an eighth control signal on the eighth switch Q8; the sixth control signal on the sixth switch Q6 is 180 degrees phase shifted from the second control signal on the second switch Q2; the fourth control signal on the fourth switch Q4 is 180 degrees phase shifted from the eighth control signal on the eighth switch Q8; and the first switch Q1 and the fifth switch Q5 maintain the conductive state.

Wherein the pre-set threshold value can be 50%, and the first timing sequence control diagram is designed according to an actual input voltage range and the specific requirements of the output voltage, and the conduction and turn-off of the switch causes the inductance assembly to be in a charged state and discharged state, thereby achieving a step down function. In one switching period, when the switch is conductive, the current of the inductance assembly rises linearly to store energy; when the switch is turned off, the inductance assembly freewheels through the other switches and the current drops linearly, releasing energy. The charging and discharging process and the energy transfer mode of the inductance assembly determine the basic timing sequence of each switch. Second, the first capacitor Cb1 and the second capacitor Cb2 in the circuit are used to filter and stabilize the output voltage. Charging and discharging are performed in different states of the switch, and the charging and discharging process thereof is also closely related to the timing sequence of the switch. When the switch is turned off, the capacitor will discharge electricity to the load to maintain the stability of the output voltage, and the timing sequence of the switch is required to match the charging and discharging characteristics of the capacitor.

In order to output a stable output voltage according to different input voltages and avoid generation of reverse current, it is necessary to precisely control the duty ratio of each switch. By controlling the duty ratio, the charge time and discharge time of the inductor can be adjusted to control a magnitude of the output voltage. Based on the preset output voltage and the actual input voltage, the control circuit calculates an appropriate duty ratio and generates a timing sequence diagram of the switch according to the duty ratio. By adjusting the pulse width, i.e. the duty ratio, of the PWM signal, the conductive and turn-off times of the switch can be controlled, thereby obtaining a timing sequence control diagram that meets the requirements of the circuit.

When the duty ratio of the power converter is less than or equal to 50%, it is available from the first timing sequence control diagram that: there will be no reverse current surge at each moment, so both the first switch Q1 and the fifth switch Q5 will always remain in the conductive state (i.e. the circuit diagram shown in FIG. 2 or 3 is now equivalent to the circuit diagram shown in FIG. 1). The state of the individual switches at each moment in time and the equivalent circuit will be described in more detail below.

Step 102: when the duty ratio of the power converter is greater than the pre-set threshold value, a second timing sequence control diagram corresponding to each switch is constructed, and the corresponding PWM control signal is generated according to the second timing sequence control diagram so as to control the turn-off or conduction of each switch, wherein the first switch Q1 is controlled to be conductive or the fifth switch Q5 is controlled to be conductive during a time period when a reverse current surge occurs, so as to avoid generation of a reverse current.

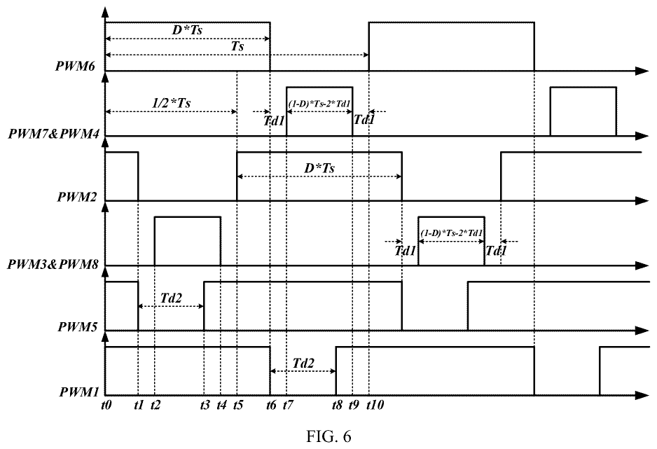

In one embodiment, as shown in FIG. 6, in the second timing sequence control diagram: a seventh control signal on the seventh switch Q7 has a same phase as a fourth control signal on the fourth switch Q4; a third control signal on the third switch Q3 has a same phase as an eighth control signal on the eighth switch Q8; a sixth control signal on the sixth switch Q6 is 180 degrees phase shifted from the seventh control signal on the seventh switch Q7; the seventh control signal on the seventh switch Q7 is also 180 degrees phase shifted from the third control signal on the third switch Q3; and the third control signal on the third switch Q3 is 180 degrees phase shifted from a second control signal on the second switch Q2.

When the duty ratio of the power converter is more than 50%, with respect to the power converter shown in embodiment 1, by increasing the switching control of the first switch Q1 and the fifth switch Q5, only one branch (the first bridge arm or the second bridge arm) of the control switch is kept in the conductive state for a period in which a current surge may occur, such that no reverse current surge occurs. The state of the individual switches at each moment in time and the equivalent circuit will be described in more detail below.

Note that, in FIGS. 5 and 6, in order to prevent the switches from being conductive at the same time during the switching to the conductive state, a first dead zone time Td1 and a second dead zone time Td2 are set to reserve a neutral time so as to accurately switch the conductive state. For example, during the time period t0-t1, the third switch Q3 and the sixth switch Q6 are in the conductive state, the fourth switch Q4 is in the turn-off state, the time period t1-t2 is the aforementioned first dead band time Td1, and in the time period t2-t3, the third switch Q3 and the sixth switch Q6 are in a turn-off state, and the fourth switch Q4 is in the conductive state.

The first dead zone time Td1 and the second dead zone time Td2 can be obtained empirically, and can be specifically set according to different operating frequencies of the circuit, different switch models, etc. and more specifically are not described in this embodiment.

In one embodiment, after the first dead zone time Td1 and the second dead zone time Td2 are obtained, the duty ratio D and the switching period Ts of the power converter are respectively determined, and the corresponding first timing sequence control diagram (as shown in FIG. 5) and the second timing sequence control diagram (as shown in FIG. 1) can be obtained.

The respective switches are controlled in combination with the duty ratio, the first timing sequence control diagram and the second timing sequence control diagram, such that the first capacitor Cb1 and the second capacitor Cb2 do not form a loop with the input capacitor Cin, or the voltages across the first capacitor Cb1 and the second capacitor Cb2 are lower than the voltage across the input capacitor Cin, so as to avoid the generation of a reverse current.

In one embodiment, as shown in FIGS. 2 and 5, the first control signal PWM1, the second control signal PWM2, the third control signal PWM3, the fourth control signal PWM4, the fifth control signal PWM5, the sixth control signal PWM6, the seventh control signal PWM7 and the eighth control signal PWM8 are respectively used for controlling the conductive states of the first switch Q1, the second switch Q2, the third switch Q3, the fourth switch Q4, the fifth switch Q5, the sixth switch Q6, the seventh switch Q7 and the eighth switch Q8.

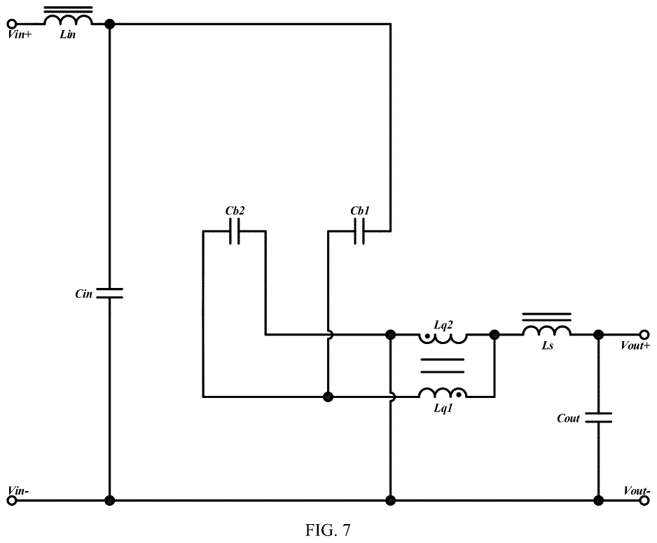

In FIG. 5, the first timing sequence control diagram can be divided into a plurality of time periods within one switching period Ts, specifically including time periods of t0-t1, t1-t2, t2-t3, t3-t4, t4-t5, t5-t6, t6-t7 and t7-t8, and the modal circuit diagrams of respective time periods in chronological order are shown in FIGS. 7 to 14.

Within one switching period Ts, taking t0 to t8 as an example, where t0-t1 and t4-t5 occupy a time equal to D*Ts, while t1-t2, t3-t4, t5-t6 and t7-t8 occupy a time equal to Td1, t0-t4 occupies a time equal to ½*Ts, and t2-t7 occupies a time equal to (1−D)*Ts−2*Td1. The level of each time period control signal is as shown in FIG. 5, wherein a high level represents that the corresponding switch is conductive, and a low level represents that the corresponding switch is turned off.

In order to further explain the change of the voltage across the first capacitor Cb1 and the voltage across the second capacitor Cb2 after different control signal combinations in each time period and the effect of the output voltage Vout, the modal circuit diagrams in each time period of t0-t8 can be referred to.

In one embodiment, FIG. 7 is a modal circuit diagram of the first timing sequence control diagram within t0-t1 of FIG. 5. With reference to FIGS. 5 and 7, within t0-t1, the sixth control signal PWM6, the third control signal PWM3, the eighth control signal PWM8, the fifth control signal PWM5 and the first control signal PWM1 are conduction control signals (namely, a high level), and the second control signal PWM2, the sixth control signal PWM6 and the fourth control signal PWM4 are turn-off control signals (namely, a low level). In this mode, the first capacitor Cb1 obtains ½ of a voltage of the input voltage Vin, an output voltage Vout satisfies Vout=½Vin*D, and a voltage across the first capacitor Cb1 does not exceed a voltage across the input capacitor Cin and therefore no recoil current is generated.

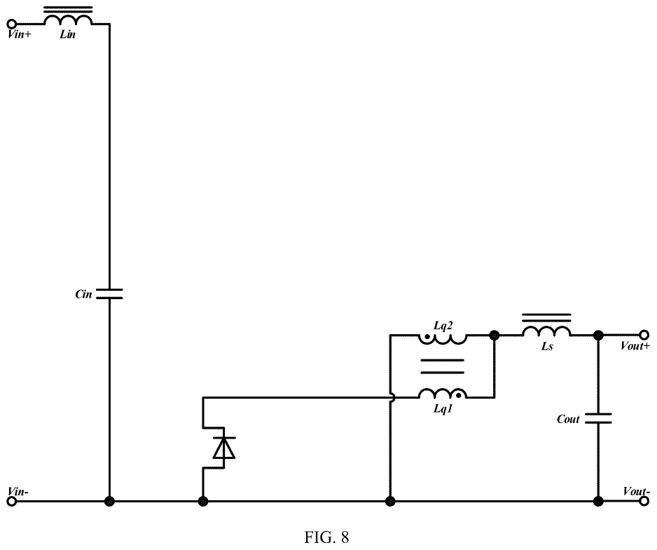

In one embodiment, FIG. 8 is a modal circuit diagram of the first timing sequence control diagram within t1-t2 of FIG. 5. With reference to FIGS. 5 and 8, within t1-t2, the eighth control signal PWM8, the fifth control signal PWM5 and the first control signal PWM1 are conduction control signals, and the sixth control signal PWM6, the second control signal PWM2, the seventh control signal PWM7, the third control signal PWM3 and the fourth control signal PWM4 are turn-off control signals. In this mode, the first capacitor Cb1 and the second capacitor Cb2 do not form a loop with the input capacitor Cin, and no recoil current is generated.

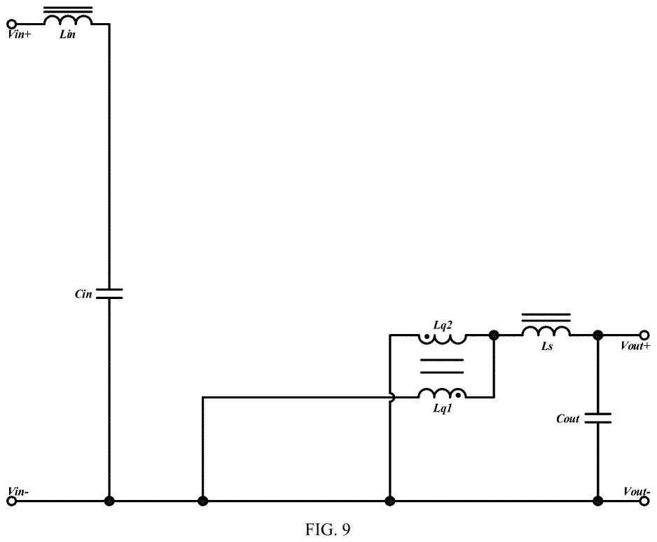

In one embodiment, FIG. 9 is a modal circuit diagram of the first timing sequence control diagram within t2-t3 of FIG. 5. Referring to FIGS. 5 and 9, within t2-t3, the eighth control signal PWM8, the fourth control signal PWM4, the fifth control signal PWM5, the first control signal PWM1 are conduction control signals, the sixth control signal PWM6, the second control signal PWM2, the seventh control signal PWM7 and the third control signal PWM3 are turn-off control signals, and in this mode, the first capacitor Cb1 and the second capacitor Cb2 do not form a loop with the input capacitor Cin, and therefore no recoil current is generated.

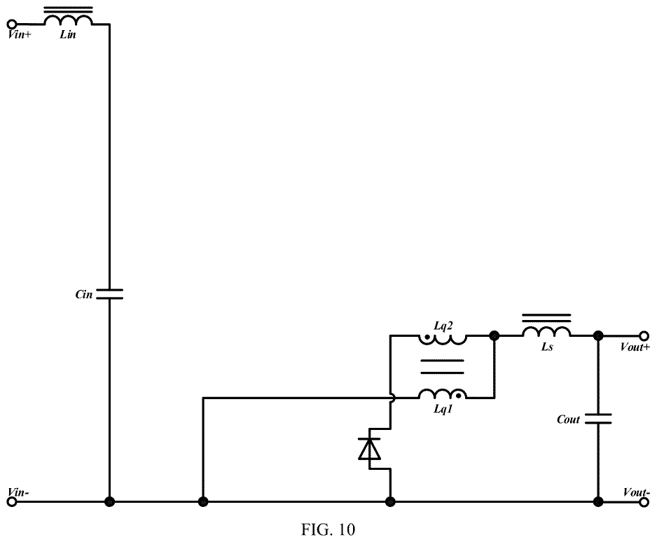

In one embodiment, FIG. 10 is a modal circuit diagram of the first timing sequence control diagram within t3-t4 of FIG. 5. Referring to FIGS. 5 and 10, within t3-t4, the fourth control signal PWM4, the fifth control signal PWM5 and the first control signal PWM1 are conduction control signals, the sixth control signal PWM6, the second control signal PWM2, the seventh control signal PWM7, the third control signal PWM3 and the eighth control signal PWM8 are turn-off control signals, and in this mode, the first capacitor Cb1 and the second capacitor Cb2 do not form a loop with the input capacitor Cin, and therefore no recoil current is generated.

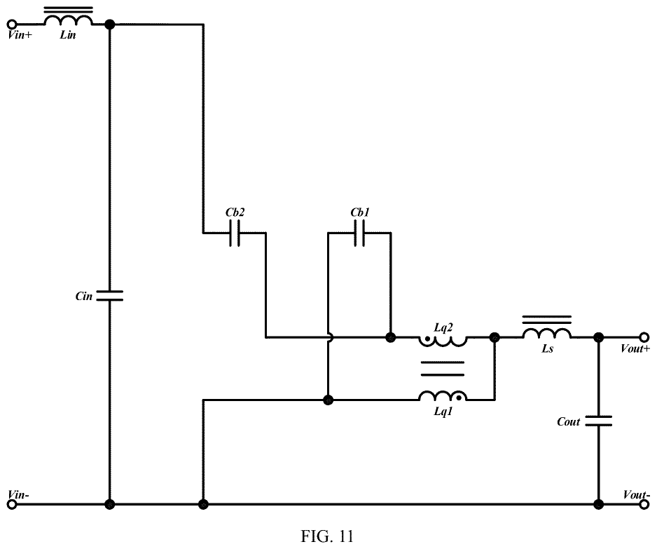

In one embodiment, FIG. 11 is a modal circuit diagram of the first timing sequence control diagram within t4-t5 of FIG. 5. With reference to FIGS. 5 and 11, within t4-t5, the second control signal PWM2, the seventh control signal PWM7, the fourth control signal PWM4, the fifth control signal PWM5, the first control signal PWM1 are conduction control signals, the sixth control signal PWM6, the third control signal PWM3 and the eighth control signal PWM8 are turn-off control signals. In this mode, the second capacitor Cb2 obtains ½ of the voltage of the input voltage Vin, the output voltage Vout satisfies Vout=½Vin*D, and the voltage at the two ends of the second capacitor Cb2 does not exceed the voltage across the input capacitor Cin, thus no recoil current is generated.

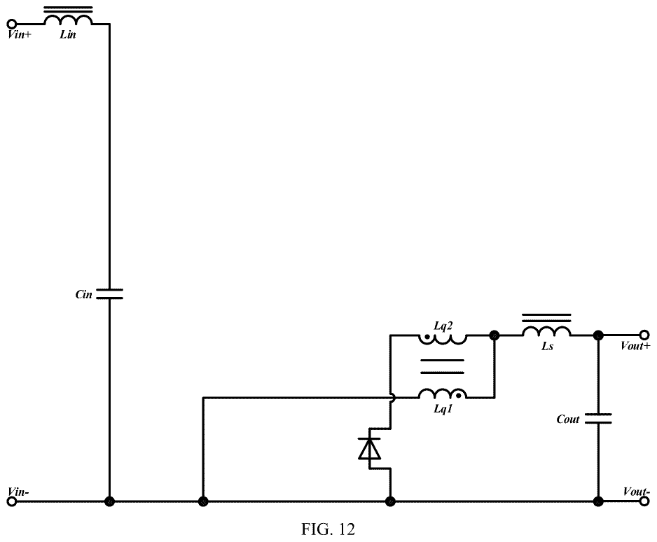

In one embodiment, FIG. 12 is a modal circuit diagram of the first timing sequence control diagram within t5-t6 of FIG. 5. Referring to FIGS. 5 and 12, within t5-t6, the fourth control signal PWM4, the fifth control signal PWM5 and the first control signal PWM1 are conduction control signals, the sixth control signal PWM6, the second control signal PWM2, the seventh control signal PWM7, the third control signal PWM3 and the eighth control signal PWM8 are turn-off control signals, and in this mode, the first capacitor Cb1 and the second capacitor Cb2 do not form a loop with the input capacitor Cin, and therefore no recoil current is generated.

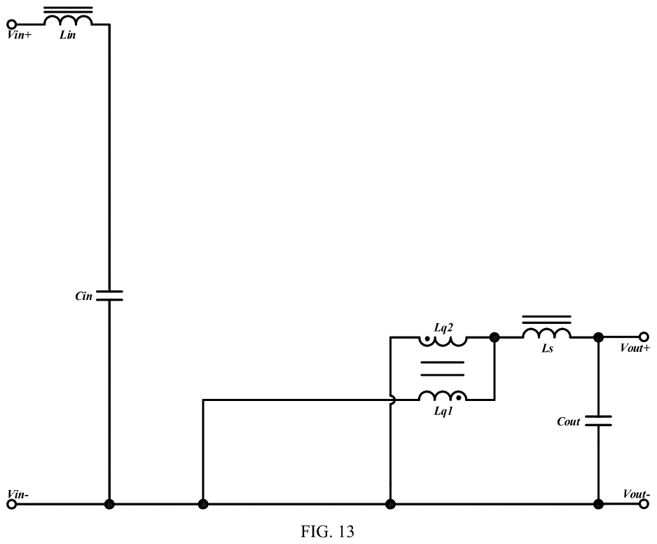

In one embodiment, FIG. 13 is a modal circuit diagram of the first timing sequence control diagram within t6-t7 of FIG. 5. Referring to FIGS. 5 and 13, within t6-t7, the eighth control signal PWM8, the fourth control signal PWM4, the fifth control signal PWM5, the first control signal PWM1 are conduction control signals, the sixth control signal PWM6, the second control signal PWM2, the seventh control signal PWM7 and the third control signal PWM3 are turn-off control signals, and in this mode, the first capacitor Cb1 and the second capacitor Cb2 do not form a loop with the input capacitor Cin, and therefore no recoil current is generated.

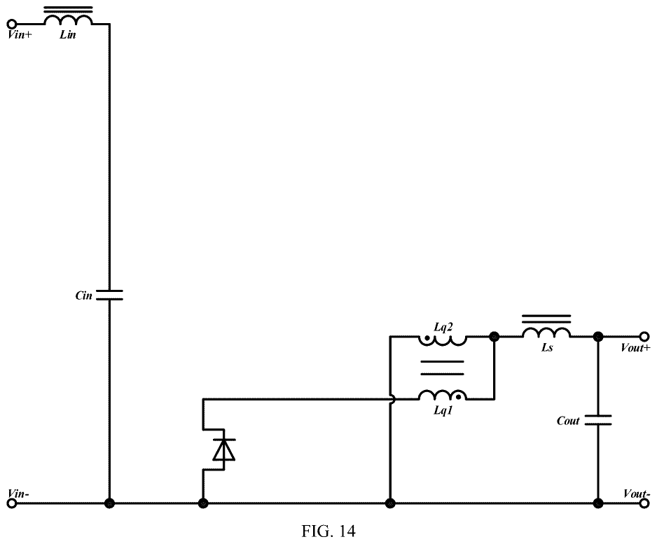

In one embodiment, FIG. 14 is a modal circuit diagram of the first timing sequence control diagram within t7-t8 of FIG. 5. Referring to FIGS. 5 and 14, within t7-t8, the eighth control signal PWM8, the fifth control signal PWM5 and the first control signal PWM1 are conduction control signals, the sixth control signal PWM6, the second control signal PWM2, the seventh control signal PWM7, the third control signal PWM3 and the fourth control signal PWM4 are turn-off control signals, and in this mode, the first capacitor Cb1 and the second capacitor Cb2 do not form a loop with the input capacitor Cin, and therefore no recoil current is generated.

In summary, it can be seen from the working principle of the modal circuit diagram in each time period of t0-t8 that when the duty ratio D is less than or equal to 50%, no reverse current surge will occur.

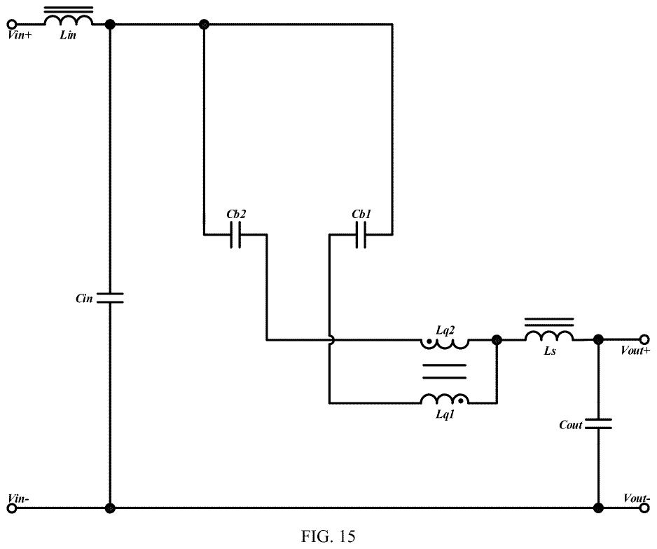

In FIG. 6, the second timing sequence control diagram can be divided into a plurality of time periods within one switching period Ts, specifically including time periods of t0-t1, t1-t2, t2-t3, t3-t4, t4-t5, t5-t6, t6-t7, t7-t8, t8-t9 and t9-t10, and the modal circuit diagrams of respective time periods in chronological order are shown in FIGS. 15 to 24.

Referring to FIG. 6, when the duty ratio D of the power converter is greater than 50%, t0 to t10 are taken as an example for one switching period Ts, where t0-t6 and t4-t10 occupy a time equal to D*Ts, while t1-t2, t4-t5, t6-t7 and t9-t10 occupy a time equal to Td1, t1-t3 and t6-t8 occupy a time equal to Td2, t0-t5 occupy a time equal to ½*Ts, and t6-t10 occupy a time equal to (1−D)*Ts−2*Td1.

In order to further explain the change of the voltage across the first capacitor Cb1 and the voltage across the second capacitor Cb2 after different control signal combinations in each time period and the effect of the output voltage Vout, the modal circuit diagrams in each time period of t0-t10 can be referred to.

In one embodiment, FIG. 15 is a modal circuit diagram of the second timing sequence control diagram within t0-t1 of FIG. 6. With reference to FIGS. 6 and 15, within t0-t1, the sixth control signal PWM6, the second control signal PWM2, the fifth control signal PWM5 and the first control signal PWM1 are conduction control signals, and the seventh control signal PWM7, the third control signal PWM3, the eighth control signal PWM8 and the fourth control signal PWM4 are turn-off control signals. In this mode, the first capacitor Cb1 and the second capacitor Cb2 equally obtain ½ of the voltage of the input voltage Vin, and the output voltage Vout satisfies Vout=½Vin*D. The voltages across the first capacitor Cb1 and the second capacitor Cb2 do not exceed the voltage across the input capacitor Cin, such that no recoil current is generated.

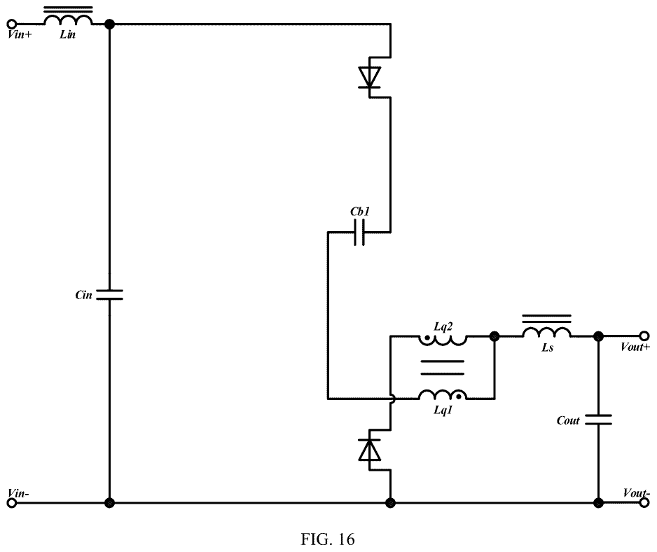

FIG. 16 is a modal circuit diagram of the second timing sequence control diagram within t1-t2 of FIG. 6. With reference to FIGS. 6 and 16, within t1-t2, the sixth control signal PWM6 and the first control signal PWM1 are conduction control signals, the second control signal PWM2, the seventh control signal PWM7, the third control signal PWM3, the eighth control signal PWM8, the fourth control signal PWM4 and the fifth control signal PWM5 are turn-off control signals. In this mode, the first capacitor Cb1 obtains ½ of the voltage of the input voltage Vin, the output voltage Vout satisfies Vout=½Vin*D, and the voltage across the first capacitor Cb1 does not exceed the voltage across the input capacitor Cin, such that no recoil current is generated.

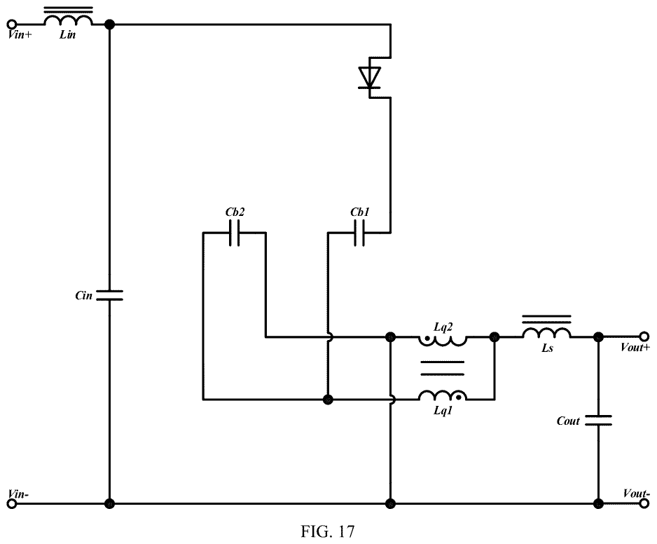

FIG. 17 is a modal circuit diagram of the second timing sequence control diagram within t2-t3 of FIG. 6. With reference to FIGS. 6 and 17, within t2-t3, the sixth control signal PWM6, the third control signal PWM3, the eighth control signal PWM8 and the first control signal PWM1 are conduction control signals, and the second control signal PWM2, the seventh control signal PWM7, the fourth control signal PWM4 and the fifth control signal PWM5 are turn-off control signals. In this mode, the first capacitor Cb1 obtains ½ of the voltage of the input voltage Vin, the output voltage Vout satisfies Vout=½Vin*D, and the voltage across the first capacitor Cb1 does not exceed the voltage across the input capacitor Cin, such that no recoil current is generated.

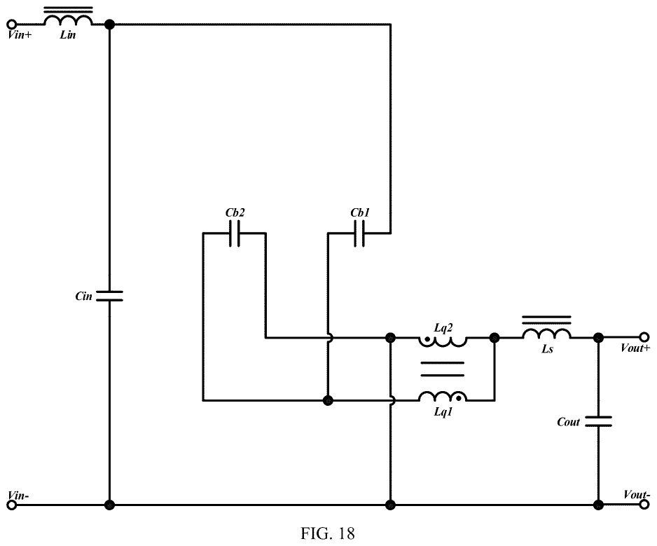

FIG. 18 is a modal circuit diagram of the second timing sequence control diagram within t3-t4 of FIG. 6. With reference to FIGS. 6 and 18, within t3-t4, the sixth control signal PWM6, the third control signal PWM3, the eighth control signal PWM8, the fifth control signal PWM5 and the first control signal PWM1 are conduction control signals, and the second control signal PWM2, the seventh control signal PWM7 and the fourth control signal PWM4 are turn-off control signals. In this mode, the first capacitor Cb1 obtains ½ of a voltage of the input voltage Vin, an output voltage Vout satisfies Vout=½Vin*D, and a voltage across the first capacitor Cb1 does not exceed a voltage across the input capacitor Cin and therefore no recoil current is generated.

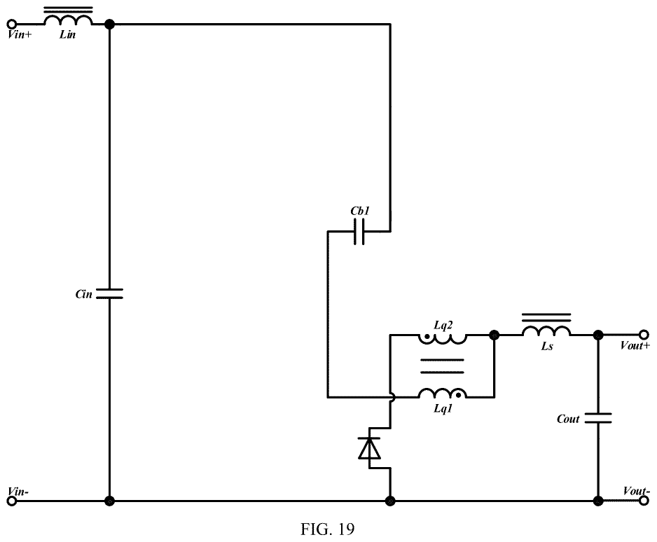

FIG. 19 is a modal circuit diagram of the second timing sequence control diagram within t4-t5 of FIG. 6. With reference to FIGS. 6 and 19, within t4-t5, the sixth control signal PWM6, the fifth control signal PWM5, and the first control signal PWM1 are conduction control signals, the second control signal PWM2, the seventh control signal PWM7, the third control signal PWM3, the eighth control signal PWM8, and the fourth control signal PWM4 are turn-off control signals. In this mode, the first capacitor Cb1 obtains ½ of the voltage of the input voltage Vin, the output voltage Vout satisfies Vout=½Vin*D, and the voltage across the first capacitor Cb1 does not exceed the voltage across the input capacitor Cin, such that no recoil current is generated.

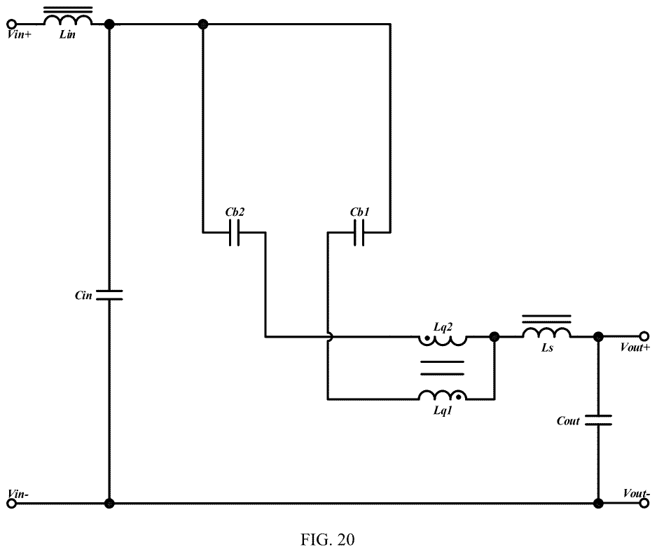

FIG. 20 is a modal circuit diagram of the second timing sequence control diagram within t5-t6 of FIG. 6. With reference to FIGS. 6 and 20, within t5-6, the sixth control signal PWM6, the second control signal PWM2, the fifth control signal PWM5 and the first control signal PWM1 are conduction control signals, and the seventh control signal PWM7, the third control signal PWM3, the eighth control signal PWM8 and the fourth control signal PWM4 are turn-off control signals. In this mode, the first capacitor Cb1 and the second capacitor Cb2 equally obtain ½ of the voltage of the input voltage Vin, and the output voltage Vout satisfies Vout=½Vin*D. The voltages across the first capacitor Cb1 and the second capacitor Cb2 do not exceed the voltage across the input capacitor Cin, such that no recoil current is generated.

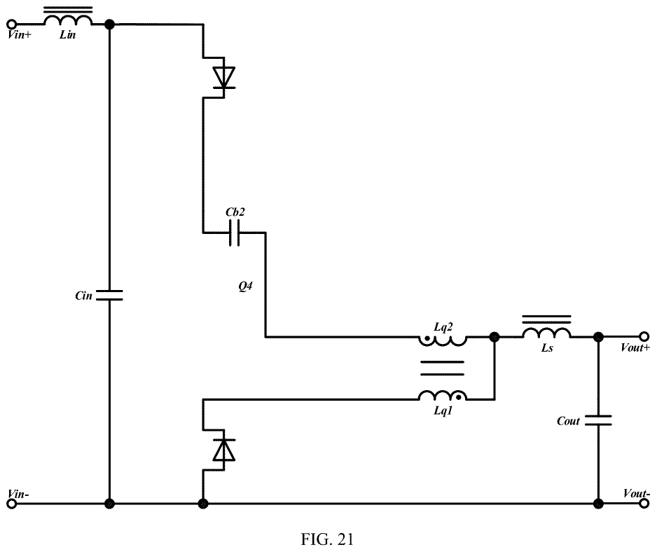

FIG. 21 is a modal circuit diagram of the second timing sequence control diagram within t6-t7 of FIG. 6. Referring to FIGS. 6 and 21, within t6-t7, the second control signal PWM2 and the fifth control signal PWM5 are conduction control signals, and the sixth control signal PWM6, the seventh control signal PWM7, the third control signal PWM3, the eighth control signal PWM8, the fourth control signal PWM4 and the first control signal PWM1 are turn-off control signals. In this mode, the second capacitor Cb2 obtains ½ of the voltage of the input voltage Vin; the output voltage Vout satisfies Vout=½Vin*D; and the voltage across the second capacitor Cb2 does not exceed the voltage across the input capacitor Cin, and therefore no recoil current is generated.

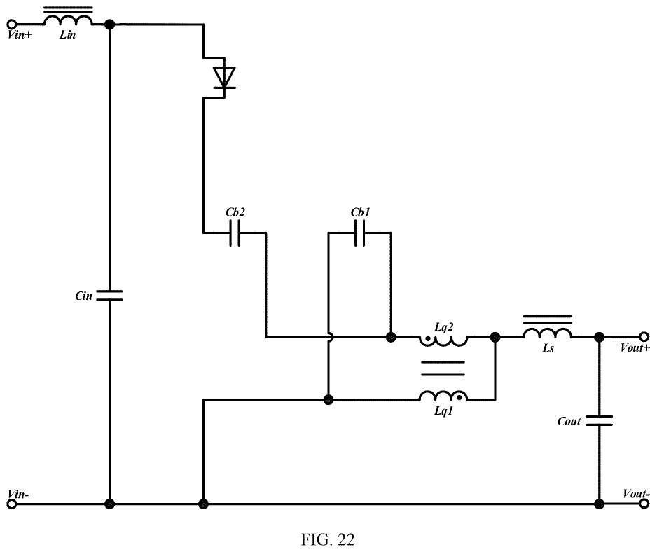

FIG. 22 is a modal circuit diagram of the second timing sequence control diagram within t7-t8 of FIG. 6. With reference to FIGS. 6 and 22, within t7-t8, the second control signal PWM2, the seventh control signal PWM7, the fourth control signal PWM4 and the fifth control signal PWM5 are conduction control signals, and the sixth control signal PW6, the third control signal PWM3, the eighth control signal PWM8 and the first control signal PWM1 are turn-off control signals. In this mode, the second capacitor Cb2 obtains ½ of the voltage of the input voltage Vin, the output voltage Vout satisfies Vout=½Vin*D, and the voltage across the second capacitor Cb2 does not exceed the voltage across the input capacitor Cin, such that no recoil current is generated.

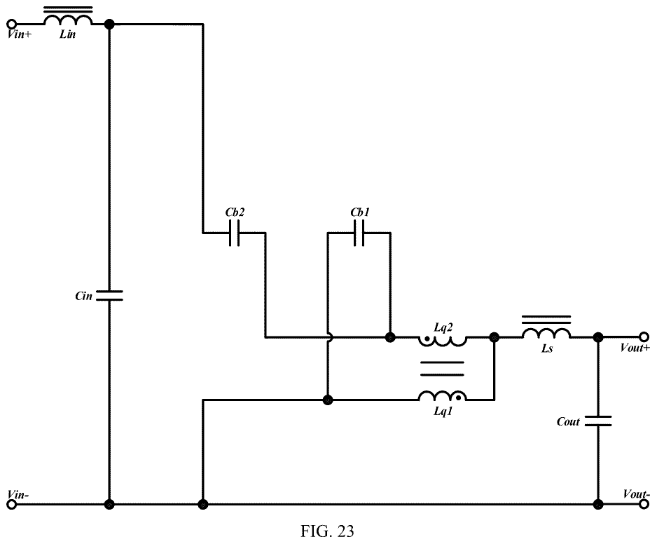

FIG. 23 is a modal circuit diagram of the second timing sequence control diagram within t8-t9 of FIG. 6. With reference to FIGS. 6 and 23, within t8-t9, the second control signal PWM2, the seventh control signal PWM7, the fourth control signal PWM4, the fifth control signal PWM5, and the first control signal PWM1 are conduction control signals, the sixth control signal PWM6, the third control signal PWM3 and the eighth control signal PWM8 are turn-off control signals. In this mode, the second capacitor Cb2 obtains ½ of the voltage of the input voltage Vin, the output voltage Vout satisfies Vout=½Vin*D, and the voltage at the two ends of the second capacitor Cb2 does not exceed the voltage across the input capacitor Cin, thus no recoil is generated.

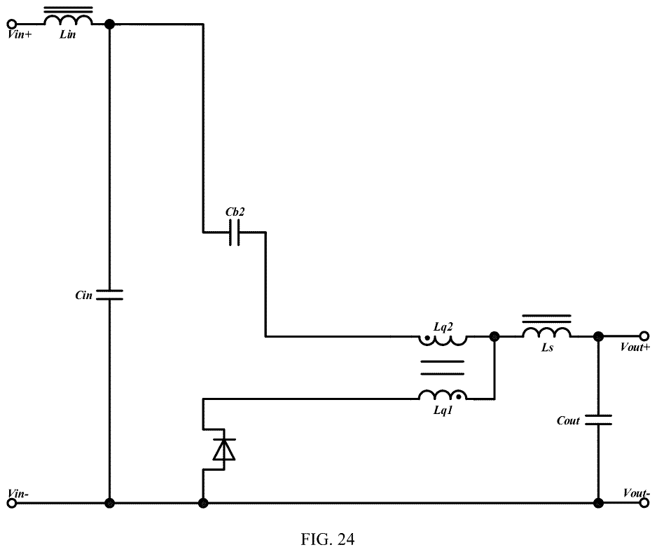

FIG. 24 is a modal circuit diagram of the second timing sequence control diagram within t9-t10 of FIG. 6. With reference to FIGS. 3 and 24, within t9-t10, the second control signal PWM2, the fifth control signal PWM5 and the first control signal PWM1 are conduction control signals, and the sixth control signal PWM6, the seventh control signal PWM7, the third control signal PWM3, the eighth control signal PWM8 and the fourth control signal PWM4 are turn-off control signals. In this mode, the second capacitor Cb2 obtains ½ of the voltage of the input voltage Vin, the output voltage Vout satisfies Vout=½Vin*D, and the voltage across the first capacitor Cb1 does not exceed the voltage across the input capacitor Cin, thus no recoil current is generated.

In summary, it can be seen from the working principle of the modal circuit diagram in each time period of t0-t10 that when the duty ratio D is greater than 50%, since the switch control of the first switch Q1 and the fifth switch Q5 is increased, only one branch (the first bridge arm or the second bridge arm) control switch is kept in the conductive state during the time period (t1-t3 and t6-t8) where a current surge may occur, such that the reverse current surge will not occur.

In summary, by providing the first switch Q1 and the fifth switch Q5, the reverse impact of the current can be prevented; since the generation of recoil current is avoided, unnecessary energy losses are reduced. When the input voltage is lower than 48 v and the duty ratio of the power converter is greater than 50%, the recoil current can still be avoided, the stability of the power converter is maintained, and the purpose of outputting a stable voltage according to a wide range of input voltage is achieved.

With regard to the specific structure of the power converter, reference is made to Embodiment 1, and the description thereof will not be repeated in this embodiment.

The foregoing description is merely preferred embodiments of the present disclosure, and is not intended to limit the present disclosure. Any modifications, equivalents, improvements, etc. within the spirit and principles of the present disclosure are intended to be included within the scope of the present disclosure.

What is claimed is:

1. A power converter, comprising: a first bridge arm composed of a plurality of switches, a second bridge arm composed of a plurality of switches, a first capacitor Cb1, a second capacitor Cb2 and an inductance assembly, wherein one end of the first bridge arm is connected to a first input end Vin+ of the power converter, and the other end thereof is connected to a second input end Vin−; one end of the second bridge arm is connected to the first input end Vin+ of the power converter, and the other end thereof is connected to the second input end Vin−; and a input capacitor Cin is provided between the first input end Vin+ and the second input end Vin−;
a second node and a third node are provided on the first bridge arm, and a first node and a fourth node are provided on the second bridge arm; and the first node, the second node, the third node and the fourth node are respectively located on a connection line between two adjacent switches;
the first node is connected to one end of the first capacitor Cb1; the other end of the first capacitor Cb1 is connected to the second node; the third node is connected to one end of the second capacitor Cb2; the other end of the second capacitor Cb2 is connected to the fourth node; the second node and the fourth node are respectively connected to one end of the inductance assembly, and the other end of the inductance assembly is connected to a first output end Vout+ of the power converter, wherein a conductive state of each switch is respectively controlled in a specific time region according to a duty ratio of the power converter, such that the first capacitor Cb1 and the second capacitor Cb2 do not form a loop with the input capacitor Cin, or voltages across the first capacitor Cb1 and the second capacitor Cb2 are both lower than a voltage across the input capacitor Cin.

2. The power converter according to claim 1, comprising: a first switch Q1, a second switch Q2, a third switch Q3 and a fourth switch Q4 successively connected to constitute the first bridge arm, and a fifth switch Q5, a sixth switch Q6, a seventh switch Q7 and an eighth switch Q8 successively connected to constitute the second bridge arm, wherein one end of the first switch Q1 and one end of the fifth switch Q5 are respectively connected to the first input end Vin+; and one end of the fourth switch Q4 and one end of the eighth switch Q8 are respectively connected to the second input end Vin−;
the first node between the sixth switch Q6 and the seventh switch Q7 is connected to one end of the first capacitor Cb1; and the other end of the first capacitor Cb1 is connected to the second node between the third switch Q3 and the fourth switch Q4;
the third node between the second switch Q2 and the third switch Q3 is connected to one end of the second capacitor Cb2; and the other end of the second capacitor Cb2 is connected to the fourth node between the seventh switch Q7 and the eighth switch Q8; and the first switch Q1 and the fifth switch Q5 share a source electrode, the first switch Q1 and the second switch Q2 share a drain electrode, and the fifth switch Q5 and the sixth switch Q6 share a drain electrode.

3. The power converter according to claim 1, comprising: a second switch Q2, a first switch Q1, a third switch Q3 and a fourth switch Q4 successively connected to constitute the first bridge arm, and a sixth switch Q6, a fifth switch Q5, a seventh switch Q7 and an eighth switch Q8 successively connected to constitute the second bridge arm, wherein one end of the second switch Q2 and one end of the sixth switch Q6 are respectively connected to the first input end Vin+; and
one end of the fourth switch Q4 and one end of the eighth switch Q8 are respectively connected to the second input end Vin−;
the first node between the fifth switch Q5 and the seventh switch Q7 is connected to one end of the first capacitor Cb1; and the other end of the first capacitor Cb1 is connected to the second node between the third switch Q3 and the fourth switch Q4;
the third node between the first switch Q1 and the third switch Q3 is connected to one end of the second capacitor Cb2; and the other end of the second capacitor Cb2 is connected to the fourth node between the seventh switch Q7 and the eighth switch Q8; and the first switch Q1 and the second switch Q2 share a source electrode, and the fifth switch Q5 and the sixth switch Q6 share a source electrode.

4. The power converter according to claim 2, wherein the power converter further comprises a PWM control module, wherein the PWM control module is respectively connected to control ends of the first switch Q1, the second switch Q2, the third switch Q3, the fourth switch Q4, the fifth switch Q5, the sixth switch Q6, the seventh switch Q7 and the eighth switch Q8; and the PWM control module is used for respectively issuing corresponding PWM control signals to the first switch Q1, the second switch Q2, the third switch Q3, the fourth switch Q4, the fifth switch Q5, the sixth switch Q6, the seventh switch Q7 and the eighth switch Q8 so as to control an on-off state of each switch at different moments.

5. The power converter according to claim 3, wherein the power converter further comprises a PWM control module, wherein the PWM control module is respectively connected to control ends of the first switch Q1, the second switch Q2, the third switch Q3, the fourth switch Q4, the fifth switch Q5, the sixth switch Q6, the seventh switch Q7 and the eighth switch Q8; and the PWM control module is used for respectively issuing corresponding PWM control signals to the first switch Q1, the second switch Q2, the third switch Q3, the fourth switch Q4, the fifth switch Q5, the sixth switch Q6, the seventh switch Q7 and the eighth switch Q8 so as to control an on-off state of each switch at different moments.

6. The power converter according to claim 2, wherein the first switch Q1, the second switch Q2, the third switch Q3, the fourth switch Q4, the fifth switch Q5, the sixth switch Q6, the seventh switch Q7 and the eighth switch Q8 have a same switching frequency.

7. The power converter according to claim 3, wherein the first switch Q1, the second switch Q2, the third switch Q3, the fourth switch Q4, the fifth switch Q5, the sixth switch Q6, the seventh switch Q7 and the eighth switch Q8 have a same switching frequency.

8. The power converter according to claim 2, wherein the power converter further comprises an input inductor Lin, an output inductor Ls and an output capacitor Cout; one end of the input inductor Lin is connected to the first input end Vin+ of the power converter, and the other end of the input inductor Lin is respectively connected to one end of the input capacitor Cin, one end of the first switch Q1 and one end of the fifth switch Q5; and one end of the output inductor Ls is connected to the other end of the inductance assembly, and the other end of the output inductor Ls is connected to the first output end Vout+ of the power converter; and one end of the output capacitor Cout is connected to the first output end Vout+ of the power converter, and the other end of the output capacitor Cout is connected to the second output end Vout− of the power converter.

9. The power converter according to claim 3, wherein the power converter further comprises an input inductor Lin, an output inductor Ls and an output capacitor Cout; one end of the input inductor Lin is connected to the first input end Vin+ of the power converter, and the other end of the input inductor Lin is respectively connected to one end of the input capacitor Cin, one end of the first switch Q1 and one end of the fifth switch Q5; and one end of the output inductor Ls is connected to the other end of the inductance assembly, and the other end of the output inductor Ls is connected to the first output end Vout+ of the power converter; and one end of the output capacitor Cout is connected to the first output end Vout+ of the power converter, and the other end of the output capacitor Cout is connected to the second output end Vout− of the power converter.

10. The power converter according to claim 2, wherein the inductance assembly is a discrete inductor, and the inductance assembly comprises a first inductor Lq1 and a second inductor Lq2, wherein one end of the first inductor Lq1 is connected to the second node, and the other end of the first inductor Lq1 is connected to the first output end Vout+ of the power converter; and one end of the second inductor Lq2 is connected to the fourth node, and the other end of the second inductor Lq2 is connected to the first output end Vout+ of the power converter.

11. The power converter according to claim 3, wherein the inductance assembly is a discrete inductor, and the inductance assembly comprises a first inductor Lq1 and a second inductor Lq2, wherein one end of the first inductor Lq1 is connected to the second node, and the other end of the first inductor Lq1 is connected to the first output end Vout+ of the power converter; and one end of the second inductor Lq2 is connected to the fourth node, and the other end of the second inductor Lq2 is connected to the first output end Vout+ of the power converter.

12. The power converter according to claim 2, wherein the inductance assembly is a coupled inductor, and the inductance assembly comprises a third inductor Lq1′ and a fourth inductor Lq2′, wherein one end of the third inductor Lq1′ is connected to the second node, and the other end of the third inductor Lq1′ is connected to the first output end Vout+ of the power converter; one end of the fourth inductor Lq2′ is connected to the fourth node, and the other end of the fourth inductor Lq2′ is connected to the first output end Vout+ of the power converter; and the third inductor Lq1′ and the fourth inductor Lq2′ are wound around one same magnetic core assembly, polarities of the third inductor Lq1′ and the fourth inductor Lq2′ are opposite, and an absolute value of a coupling coefficient of the third inductor Lq1′ and the fourth inductor Lq2′ ranges from 0 to 1.

13. The power converter according to claim 3, wherein the inductance assembly is a coupled inductor, and the inductance assembly comprises a third inductor Lq1′ and a fourth inductor Lq2′, wherein one end of the third inductor Lq1′ is connected to the second node, and the other end of the third inductor Lq1′ is connected to the first output end Vout+ of the power converter; one end of the fourth inductor Lq2′ is connected to the fourth node, and the other end of the fourth inductor Lq2′ is connected to the first output end Vout+ of the power converter; and the third inductor Lq1′ and the fourth inductor Lq2′ are wound around one same magnetic core assembly, polarities of the third inductor Lq1′ and the fourth inductor Lq2′ are opposite, and an absolute value of a coupling coefficient of the third inductor Lq1′ and the fourth inductor Lq2′ ranges from 0 to 1.

14. A control method of a power converter, wherein the control method is implemented in the power converter according to claim 1, comprising:
when the duty ratio of the power converter is less than or equal to a pre-set threshold value, constructing a first timing sequence control diagram corresponding to each switch, and generating a corresponding PWM control signal according to the first timing sequence control diagram so as to control turn-off or conduction of each switch; and when the duty ratio of the power converter is greater than the pre-set threshold value, constructing a second timing sequence control diagram corresponding to each switch, and generating the corresponding PWM control signal according to the second timing sequence control diagram so as to control the turn-off or conduction of each switch.

15. The control method of a power converter according to claim 14, wherein the first bridge arm comprises a first switch Q1, a second switch Q2, a third switch Q3 and a fourth switch Q4, and the second bridge arm comprises a fifth switch Q5, a sixth switch Q6, a seventh switch Q7 and an eighth switch Q8, and in the first timing sequence control diagram:
a sixth control signal on the sixth switch Q6 has a same phase as a third control signal on the third switch Q3; a second control signal on the second switch Q2 has a same phase as a seventh control signal on the seventh switch Q7; the sixth control signal on the sixth switch Q6 is 180 degrees phase shifted from a fourth control signal on the fourth switch Q4; the second control signal on the second switch Q2 is 180 degrees phase shifted from an eighth control signal on the eighth switch Q8; the sixth control signal on the sixth switch Q6 is 180 degrees phase shifted from the second control signal on the second switch Q2; the fourth control signal on the fourth switch Q4 is 180 degrees phase shifted from the eighth control signal on the eighth switch Q8; and the first switch Q1 and the fifth switch Q5 maintain the conductive state.

16. The control method of a power converter according to claim 14, wherein the first bridge arm comprises a first switch Q1, a second switch Q2, a third switch Q3 and a fourth switch Q4, and the second bridge arm comprises a fifth switch Q5, a sixth switch Q6, a seventh switch Q7 and an eighth switch Q8, and in the second timing sequence control diagram:
a seventh control signal on the seventh switch Q7 has a same phase as a fourth control signal on the fourth switch Q4; a third control signal on the third switch Q3 has a same phase as an eighth control signal on the eighth switch Q8; a sixth control signal on the sixth switch Q6 is 180 degrees phase shifted from the seventh control signal on the seventh switch Q7; the seventh control signal on the seventh switch Q7 is also 180 degrees phase shifted from the third control signal on the third switch Q3; and the third control signal on the third switch Q3 is 180 degrees phase shifted from a second control signal on the second switch Q2.
